(19) United States
(12) Patent Application Publication
(10) Pub. No.: US 2025/0002393 A1
(43) Pub. Date: Jan. 2, 2025

(54) CHEMICALLY STRENGTHENED GLASS-BASED ARTICLES

(71) Applicant: CORNING INCORPORATED, CORNING, NY (US)

(72) Inventors: Jeffrey Alan Decker, Broomall, PA (US); Zhenhua Guo, Painted Post, NY (US); Pascale Oram, Painted Post, NY (US); Rostislav Vatchev Roussev, Painted Post, NY (US)

(21) Appl. No.: 18/743,855

(22) Filed: Jun. 14, 2024

Related U.S. Application Data
(60) Provisional application No. 63/522,024, filed on Jun. 20, 2023.

(51) Int. Cl. C03C 3/083; G06F 1/16

(52) U.S. Cl. CPC C03C 3/083; G06F 1/1656

(57) ABSTRACT

A lithium aluminosilicate glass-based article includes greater than or equal to 55.0 mol % and less than or equal to 75.0 mol % SiO₂, greater than or equal to 1.0 mol % and less than or equal to 18.0 mol % Al₂O₃, and greater than or equal to 9.0 mol % and less than or equal to 25.0 mol % Li₂O. The glass-based article has a thickness less than 0.74 mm, a fracture toughness of the mid-plane composition of the glass-base article is greater than or equal to 0.75 MPα\sqrt{m}, and a depth of compression that is greater than or equal to 0.14t, where t is the thickness of the glass-based article. The glass-based article is designed to have a single guided mode in the prism coupling spectrum at a wavelength between 360 nm and 405 nm for at least one of the transverse-magnetic or transverse-electric polarization.

This application claims the benefit of priority under 35 U.S.C. § 119 of U.S. Provisional Application Ser. No. 63/522,024 filed on Jun. 20, 2023, the content of which is relied upon and incorporated herein by reference in its entirety.

### BACKGROUND

### Field

The present specification generally relates to lithium aluminosilicate glasses and lithium aluminosilicate glass-ceramics. More specifically, the present specification is directed to lithium-containing alkali aluminosilicate glasses and lithium aluminosilicate glass-ceramics with tuned mechanical properties for producing low-cost glass and glass-ceramic articles having low thicknesses, high fracture toughness, and high depth of compression.

### Technical Background

There is a continuous need to provide glass and glass-ceramic articles that have the mechanical properties needed to function as covers for portable electronic devices, such as, for example, mobile phones, tablets, smart watches and the like. Glass and glass-ceramics used for such purposes should have certain mechanical properties such as strength to resist cracking and shattering and scratch resistance. These mechanical properties are, at least in part, related to the stress profile of the glass or glass-ceramic articles, which includes compressive stress and central tension.

### SUMMARY

The present disclosure is directed to glass and glass-ceramic compositions having stress profiles that can easily and quickly be measured for quality-control purposes by prism coupling spectrums.

A first aspect includes a lithium aluminosilicate glass-based article comprising: greater than or equal to 55.0 mol % and less than or equal to 75.0 mol % SiO₂; greater than or equal to 1.0 mol % and less than or equal to 18.0 mol % Al₂O₃; and greater than or equal to 9.0 mol % and less than or equal to 25.0 mol % Li₂O, wherein the glass-based article has a thickness less than 0.74 mm, a fracture toughness of the mid-plane composition of the glass-base article is greater than or equal to 0.75 MPα\sqrt{m}, a depth of compression that is greater than or equal to 0.14t, where t is the thickness of the glass-based article, and the glass-based article is designed to have a single guided mode in the prism coupling spectrum at a wavelength between 360 nm and 405 nm for at least one of the transverse-magnetic or transverse-electric polarization.

A second aspect includes a glass-based article of the first aspect, wherein the glass-based article has a thickness that is less than or equal to 0.67 mm.

A third aspect includes a glass-based article of any of the preceding aspects, wherein the glass-based article has a thickness that is less than or equal to 0.43 mm.

A fourth aspect includes a glass-based article of any of the preceding aspects, wherein the glass-based article has a fracture toughness that is greater than or equal to 0.80 MPα\sqrt{m}.

A fifth aspect includes a glass-based article of any of the preceding aspects, wherein the glass-based article has a fracture toughness that is greater than or equal to 0.85 MPα\sqrt{m}.

A sixth aspect includes a glass-based article of any of the preceding aspects, wherein the glass-based article is a glass-ceramic.

A seventh aspect includes a glass-based article of any of the preceding aspects, wherein the glass-based article has a fracture toughness that is greater than or equal to 1.00 MPα\sqrt{m}.

An eighth aspect includes a glass-based article of any of the preceding aspects, wherein the glass-based article has a fracture toughness that is greater than or equal to 1.10 MPα\sqrt{m}.

A ninth aspect includes a glass-based article of any of the preceding aspects, wherein the glass-based article has a surface compressive stress that is greater than or equal to 150 MPa.

A tenth aspect includes a glass-based article of any of the preceding aspects, wherein the glass-based article has a CSₖ that is greater than or equal to (20+100*t), where t is the thickness of the glass-based article measured in mm.

An eleventh aspect includes a glass-based article of any of the preceding aspects, wherein both a transverse-magnetic (TM) and a transverse-electric (TE) spectra have a single fringe corresponding to a guided optical mode at a wavelength between 360 nm and 405 nm.

A twelfth aspect includes a glass-based article of any of the preceding aspects, wherein the spacing between one guided mode and a critical angle is greater than or equal to 0.00012 refractive-index units (RIU) for at least one of the TM and TE polarizations.

A thirteenth aspect includes a glass-based article of any of the preceding aspects, wherein the spacing between one guided mode and a critical angle is greater than or equal to 0.00012 RIU for both the TM and TE polarizations.

A fourteenth aspect includes a glass-based article of any of the preceding aspects, wherein the spacing between the one guided mode and the critical angle is greater than or equal to 0.00020 RIU for at least one of the TM and TE polarizations.

A fifteenth aspect includes a glass-based article of any of the preceding aspects, wherein the spacing between the one guided mode and the critical angle is greater than or equal to 0.00030 RIU for at least one of the TM and TE polarizations.

A sixteenth aspect includes a glass-based article of any of the preceding aspects, wherein the glass-based article has a center tension that is less than or equal to 80 MPa.

A seventeenth aspect includes a glass-based article of any of the preceding aspects, wherein the glass-based article has a center tension that is less than or equal to 70 MPa.

An eighteenth aspect includes a glass-based article of any of the preceding aspects, wherein the glass-based article has a center tension that is less than or equal to 60 MPa.

A nineteenth aspect includes a glass-based article of any of the preceding aspects, wherein the glass-based article has a center tension that is greater than or equal to 40 MPa.

A twentieth aspect includes a glass-based article of any of the preceding aspects, wherein the glass-based article comprises: greater than or equal to 60.0 mol % and less than or equal to 75.0 mol % SiO₂; greater than or equal to 1.0 mol % and less than or equal to 8.0 mol % Al₂O₃; and greater than or equal to 10.0 mol % and less than or equal to 25.0 mol % Li₂O.

A twenty-first aspect includes a glass-based article of any of the preceding aspects, wherein the glass-based article further comprises: greater than or equal to 0.2 mol % and less than or equal to 1.6 mol % Na₂O; greater than or equal to 0.05 mol % and less than or equal to 1.5 mol % K₂O; and greater than or equal to 0.5 mol % and less than or equal to 5.5 mol % ZrO₂.

A twenty-second aspect includes a glass based article of any of the preceding aspects, wherein the glass-based article is strengthened by an ion-exchange process comprising: heating an ion-exchange solution to a temperature that is greater than or equal to 450° C. to less than or equal to 550° C., the ion exchange solution comprising the following molten salts: greater than or equal to 12 wt % and less than or equal to 30 wt % NaNO₃; greater than or equal to 0.02 wt % and less than or equal to 0.1 wt % LiNO₃, and greater than or equal to 75 wt % and less than or equal to 80 wt % KNO₃; and contacting the glass-based article with the ion exchange solution for a duration that is greater than or equal to 7 minutes and less than or equal to 210 minutes.

A twenty-third aspect includes a glass-based article of any of the preceding aspects, wherein the glass-based article is a 2-dimensional glass-based article.

A twenty-fourth aspect includes a glass-based article of any one of the first to twenty-second aspects, wherein the glass-based article is a 2.5-dimensional glass-based article.

A twenty-fifth aspect includes a glass-based article of any one of the first to twenty-second aspects, wherein the glass-based article is a 3-dimensional glass-based article.

A twenty-sixth aspect includes an electronic product (200) comprising: a housing (202) having a front surface (204), a back surface (206), and side surfaces (208); a display (210); and a cover substrate (212) disposed over the front surface (204), wherein the cover substrate (212) is a glass-based article any of the preceding aspects.

Additional features and advantages will be set forth in the detailed description, which follows, and in part will be readily apparent to those skilled in the art from that description or recognized by practicing the embodiments described herein, including the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic of a glass-based article comprising compressive stress layers on the surfaces thereof;

FIG. 2 is an exemplary compressive stress profile of a glass-based article according to embodiments disclosed and described herein;

FIG. 3A is an exemplary prism-coupling spectrum having 1-fringe according to embodiments disclosed and described herein;

FIG. 3B is an exemplary prism-coupling spectrum having multiple fringes;

FIG. 4 is a schematic of an exemplary article incorporating any of the glass-based articles according to embodiments disclosed and described herein;

FIG. 5 is a prism-coupling spectrum at 365 nm for specimen of 0.6-mm-thick glass-based article, ion exchanged at 530° C. for 140 min in a salt bath comprising 20 wt % NaNO₃, 0.1 wt % LiNO₃, and about 79.9 wt % KNO₃, with additive of 1 wt % silicic acid;

FIG. 6 is a prism-coupling spectrum at 365 nm for specimen of 0.6-mm-thick glass-based article ion exchanged at 470° C. for 160 min in a salt bath comprising 40 wt % NaNO₃, 0.1 wt % LiNO₃, and 59.9 wt % KNO₃;

FIG. 7 is an RNF stress-profiles measured on approximately 0.6-mm-thick specimens of glass-based articles ion exchanged according to the conditions of FIG. 5 (dashed line) and FIG. 6 (continuous line);

FIG. 8 is a prism-coupling spectrum at 365 nm for 0.6-mm-thick 3D-formed glass-based article ion-exchanged in 40 wt % NaNO₃, 0.1 wt % LiNO₃, and 59.9 wt % KNO₃ at 470° C. for 160 minutes;

FIG. 9 is a prism-coupling spectrum at 365 nm for 0.6 mm-thick 2D glass-ceramic article ion-exchanged in a bath of 25 wt % NaNO₃, 0.05 wt % LiNO₃, and 74.95 wt % KNO₃ at 500° C. for 90 minutes;

FIG. 10 is a compressive-stress profiles for ALD glass-ceramic articles ion exchanged according to the conditions for FIG. 7 (dash-dotted) and FIG. 8 (continuous), compared to the profile of drop-test article prepared according to conditions for FIG. 6;

FIG. 11 is a peak/center tension (PT, CT) of 0.6-mm-thick glass-ceramic, with 3D-forming thermal treatment prior to ion exchange, as a function of ion-exchange time at 500° C. and an ion-exchange bath contains approximately 20 wt % NaNO₃, 79.95 wt % KNO₃, and 0.05 wt % LiNO₃, with 1 wt % silicic acid additive;

FIG. 12 is a prism-coupling spectra at 365 nm for 0.6-mm chemically-strengthened glass-ceramic article with 3D-thermal treatment, illustrating some examples of the preferred feature 1-fringe spectrum;

FIG. 13A is a prism-coupling spectrum at 365 nm of 0.49 mm glass-ceramic article, as-cerammed, without 3D-forming heat treatment, following ion exchange for 100 min at 500° C. in 15 wt % NaNO₃, 0.033 wt % LiNO₃, and the rest approximately 85 wt % of KNO₃;

FIG. 13B is a stress profile of 0.49-mm specimen of FIG. 13A, following removal of 2 micron of material per side for improving surface strength;

FIG. 14A is a prism-coupling spectra of 0.4-mm glass-ceramic article without 3D thermal treatment at 500° C. in 22 wt % NaNO₃, 0.027 wt % LiNO₃, and 87.963 wt % KNO₃ with 1 wt % silicic acid additive, for 3 ion-exchange times (60 min, 75 min, and 90 min) post ion exchange without removal, with 1.6 to 1.7-micron removal per side, and 2-micron removal per side;

FIG. 14B is a stress profile for a specimen of 0.42-mm-thick glass-ceramic article having 90-min ion exchange and 2-micron per side post-ion-exchange material removal;

FIG. 15 is a spectrum showing changes in the 1-fringe target spectrum with LiNO₃ content in the bath, and with TSP-addition on a 0.6 mm thick glass-ceramic article ion exchanged in a bath of 20 wt % NaNO₃. 0.03 wt % LiNO₃, and 79.97 wt % KNO₃ at 500° C. for 130 minutes;

FIG. 16 is a 365 nm prism-coupling spectrum for glass-ceramic having a thickness of 0.57 mm ion-exchanged in 25 wt % NaNO₃, 0.5 wt % LiNO₃ at 500° C. for 3.5 hrs.;

FIG. 17 is a RNF stress profile 0.57 mm thick glass-ceramic article of FIG. 16;

FIG. 18 is a FSM spectrum at 365 nm for 3D-formed glass-ceramic having a thickness of 0.5 mm, ion-exchanged in 25 wt % NaNO₃ 0.5 wt % LiNO₃ 500° C. for 2.43 hrs.;

FIG. 19 is a RNF compressive-stress profile of a 0.5 mm thick glass-ceramic article of FIG. 18; and

FIG. 20 is a prism-coupling spectrum at 365 nm of 0.412 mm-thick lithium-alumino-silicate glass having fracture toughness of 0.89 MPα\sqrt{m}, ion-exchanged at 450° C. for 2.5 hours in a molten-salt bath having about 4.95 wt % NaNO₃, 93.56 wt % KNO₃, and about 1.49 wt % LiNO₃, and the bath also had additive of 0.5 wt % silicic acid.

### DETAILED DESCRIPTION

This disclosure is directed to chemically strengthened cover glass for portable electronic devices, such as smart phones, tablets, smart watches, and premium portable laptop computers. Glasses and glass ceramics (also referred to herein as glass-based compositions or glass-based articles as appropriate) with increased fracture toughness above 0.8 or 0.85 MPα\sqrt{m}, when chemically strengthened, typically offer superior fracture resistance then previous generations of chemically strengthened cover glass with fracture toughness of 0.7 about MPα\sqrt{m}. For glass-based articles there are a variety of failure modes, and at least two of them (surface “overstress” and edge “overstress”) are related to high-stress events wherein relatively shallow flaws are subjected to high tensile bending stresses. A surface spike of high compressive stress in the stress profile has been used with high-DOC profiles to help increase fracture resistance against these failure modes. In addition, such a surface spike can, in some cases, help improve scratch resistance. In chemically strengthened lithium-aluminosilicate (LAS) glass-based compositions, the most-used profiles have high DOC owing to a deep profile of sodium (Na)—concentration gradient, and a surface spike produced by a relatively shallow region enriched with potassium (K)—ions through ion exchange. The diffusivity of K ions in the chemical strengthening is usually at least three orders of magnitude lower than that of Na ions. The K-spike on the surface may be used in quality control to determine the attributes of the chemical strengthening through prism-coupling measurements, where at least two transverse-magnetic (TM) and two transverse electric (TE) fringes formed by the K-profile are used to calculate compressive stress (CS) and depth of layer (DOL) of the K-spike. The requirements for the depth and concentration of the K-distribution to form these at least two fringes impose requirements on the total diffusion time, which can be problematic. In particular, they are problematic in the cases of some advanced glasses and glass ceramics having high fracture toughness and relatively low thickness, because it takes a long time for the K profile to form two fringes, by which time the Na diffusion goes past the optimum space for the deep stress profile. The deep profile is then “over-ion-exchanged”, in the sense that the stress-area of the profile is significantly decreased compared to the maximum area for a particular ion-exchanged salt mixture, the peak tension (PT) is decreased compared to the maximum PT for the particular ion-exchanged salt mixture, the ion exchange time is unnecessarily long which increases production cost, and the lithium (Li)—poisoning of the bath is unnecessarily higher than what is needed for an optimum high-DOC profile.

Glass-based articles disclosed and described herein have a surface spike that produces a single fringe in a prism-coupling measurement in the TM or TE polarization state, or both. For transparent cover-glass products, such as cover glasses for phone screens and tablet screens, this would be a single fringe when the measurement is obtained at a wavelength of 405 nm or less, and preferably 385 nm or less. Low-cost quality control (QC) for lithium-alumino-silicate glasses and glass-ceramics can be utilized by evaluating glass-based articles for this single fringe utilizing existing prism-coupling stress meters already available in state-of-the-art production facilities. This QC methodology can take the place of costly, time-consuming traditional and state-of-the-art techniques that are used to measure the stress profiles of glass-based articles such as integrated stress meters utilizing at least in part the method of scattered-light polarimetry.

The QC advantages are particularly strong for the cases of glass-ceramics and glasses that have relatively low to moderate PT (e.g., below about 90 MPa), and in general for thinner glass-based articles (e.g., glass-based articles with a thickness below 0.74 mm or below 0.50 mm, as described below). In all of these cases, scattered-light polarimetry has relatively poor performance for QC due to the limited PT, relatively small thickness, or particularly high optical (speckle) noise especially with the transparent glass-ceramic articles. Glass-based articles disclosed and described herein formulated to have a one-fringe surface spike have the advantages of: provides a means of low-cost QC; useful CS-boost in the first few microns to increase resistance to high-stress fractures; do not cause decreased performance of the deep portion of the profile due to non-optimum condition for the deep profile; and do not cause cost increase due to excessive ion-exchange time that is required to get to a two-fringe spike. Further advantages include low-cost quality control, allowing every manufactured part to be measured very quickly using existing evanescent prism-coupling (EPC) stress meters. This method of QC has a significantly lower cost compared to using SLP, particularly for thin glasses and glass-ceramics in cases where frangibility is not an issue (i.e., where PT is not too high). The one-fringe EPC-based QC applies equally well to glass-based articles with low thicknesses, such as thicknesses below 0.45 mm, 0.42 mm and even below 0.35 mm compared to larger thicknesses. In contrast, the performance of SLP-based QC strongly degrades at lower thicknesses due to the useful signal being proportional to the thickness and to the PT.

Another advantage of the glass-based articles disclosed and described herein is a higher surface CS compared to an article made of the same base glass or glass ceramic that does not have the 1-fringe K surface spike. When compared to a 2-fringe surface spike implemented in the same glass or glass-ceramic, glass-based articles disclosed and described herein have either higher compressive stress at the knee (knee-stress, or CSₖ), or higher CSₖ and higher surface CS, in addition to the reduced manufacturing cost, increased PT, or stress integral of the deep portion of the stress profile.

As described hereinabove, it has unexpectedly been discovered that glass-based articles that exhibit one fringe in a prism-coupling spectrum have advantageous properties for use as covers on electronic devices and QC of such glass-based articles can easily be had by observing the single fringe of such glass-based articles, thus making such glass-based compositions ideal for such applications, especially when the cover-glass thickness is relatively small. Accordingly, glass-based articles according to embodiments disclosed and described herein are formulated from glass-based compositions that can be chemically strengthened to have a stress profile that provides a single fringe when evaluated with prism-coupling spectrum analysis.

Reference will now be made in detail to lithium aluminosilicate glass-based compositions according to various embodiments. The physical properties of lithium aluminosilicate glass-based articles generally may be related to the glass-based composition and strengthening treatments thereof.

To that end, lithium aluminosilicate glass-based compositions have good ion exchange ability, and chemical strengthening processes have been used to achieve high strength and high toughness properties in alkali aluminosilicate glass-based compositions. Lithium aluminosilicate glass-based compositions are highly ion exchangeable with good formability and quality. The substitution of Al₂O₃into the silicate glass-based network increases the interdiffusivity of monovalent cations during ion exchange. The diffusivity, as measured in diffusion coefficients, is one of the key factors in determining the ion-exchange ability in lithium aluminosilicate glass-based compositions, which depends on the glass framework and ion sizes. By chemical strengthening in a molten salt bath (e.g., KNO₃), glass-based articles with high strength and high toughness can be achieved.

Described herein are lithium aluminosilicate glass-based compositions that may be ion-exchanged to achieve high CS at a good DOL, according to embodiments, physical properties of lithium aluminosilicate glass-based compositions according to embodiments, and ion exchange ability benefits of lithium aluminosilicate glass-based compositions according to embodiments before and after ion exchange.

In embodiments of glass-based compositions described herein, the concentration of constituent components (e.g., SiO₂, Al₂O₃, and the like) are given in mole percent (mol %) on an oxide basis, unless otherwise specified. Components of the lithium aluminosilicate glass-based composition according to embodiments are discussed individually below. It should be understood that any of the variously recited ranges of one component may be combined with the any of the variously recited ranges for any other component.

According to embodiments, the main glass-forming component is silica (SiO₂), which is the largest constituent of the composition and, as such, is the primary constituent of the resulting glass network. Without being bound to theory, SiO₂ enhances the chemical durability of the glass and, in particular, the resistance of the glass-based composition to decomposition in acid and the resistance of the glass-based composition to decomposition in water. If the content of SiO₂ is too low, the chemical durability and chemical resistance of the glass may be reduced and the glass may be susceptible to corrosion. Accordingly, a high SiO₂ concentration is generally desired in embodiments. However, if the content of SiO₂ is too high, the formability of the glass may be diminished as higher concentrations of SiO₂ may increase the difficulty of melting the glass, which, in turn, adversely impacts the formability of the glass.

In embodiments, the glass-based composition generally comprises SiO₂ in an amount greater than or equal to 55.0% and less than or equal to 75.0 mol %. In embodiments, the glass-based composition comprises SiO₂ in amounts greater than or equal to 62.0 mol % or greater than or equal to 65.0 mol %. In embodiments, the glass-based composition comprises SiO₂ in amounts less than or equal to 72.0 mol % or less than or equal to 70.0 mol %. In embodiments, the glass-based composition comprises SiO₂ in an amount greater than or equal and 62.0 mol % and less than or equal and 72.0 mol %, such as greater than or equal to 65.0 mol % and less than or equal to 70.0 mol %, or greater than or equal to 67.0 mol % and less than or equal to 69.0 mol %, and all ranges and subranges within the disclosed ranges. In one or more embodiments, the glass-based composition comprises greater than or equal to 55.0 mol % and less than or equal to 70.0 mol %, such as greater than or equal to 60.0 mol % and less than or equal to 70.0 mol %, or greater than or equal to 60.0 mol % and less than or equal to 65.0 mol %, and all ranges and subranges within the disclosed ranges.

The glass-based composition of embodiments may further comprise Al₂O₃. Al₂O₃ may serve as a glass network former, similar to SiO₂. Al₂O₃ may increase the viscosity of the glass-based composition due to its tetrahedral coordination in a glass melt formed from a properly designed glass-based composition, decreasing the formability of the glass-based composition when the amount of Al₂O₃ is too high. However, when the concentration of Al₂O₃ is balanced against the concentration of SiO₂ and the concentration of alkali oxides in the glass-based composition, Al₂O₃ can reduce the liquidus temperature of the glass melt, thereby enhancing the liquidus viscosity and improving the compatibility of the glass-based composition with certain forming processes, such as the fusion forming process.

In embodiments, the glass-based composition generally comprises Al₂O₃ in a concentration of greater than or equal to 1.0 mol % and less than or equal to 18.0 mol %, such as greater than or equal to 2.0 mol % and less than or equal to 7.0 mol %, greater than 3.0 mol % and less than or equal to 6.0 mol %, greater than or equal to 3.5 mol % and less than or equal to 6.5 mol %, or greater than or equal to 3.5 mol % and less than or equal to 6.0 mol %, and all ranges and subranges within the disclosed ranges. In one or more embodiments, the glass-based article comprises greater than or equal to 10.0 mol % and less than or equal to 18.0 mol %, such as greater than or equal to 12.0 mol % and less than or equal to 16.0 mol %, or greater than or equal to 14.0 mol % and less than or equal to 16.0 mol %, and all ranges and subranges within the disclosed ranges.

According to embodiments, the glass-based composition may also comprise alkali metal oxides, such as Li₂O, Na₂O and K₂O, for example. The combination of these alkali metal oxides (e.g. Li₂O+Na₂O+K₂O) may also be referred to as R₂O. In embodiments, R₂O is greater than 18.0 mol %, such as greater than 19.0 mol %, or greater than or equal to 20.0 mol %. By having a glass-based composition with this amount of alkali metal oxides, and particularly Li₂O, a deep depth of compression (DOC) and surface compressive stress (CS) may be obtained. In addition, alkali metal oxides, and especially Li₂O, provide short ion-exchange time with high DOC and high central tension (CT).

In embodiments, other alkali metal oxides, such as Rb₂O and Cs₂O, may also be present in the glass-based compositions. These alkali metal oxides may reduce the liquidus temperature and increase the liquidus viscosity, then preserving the glass forming melt from crystallization at high temperatures. However, these alkali metal oxides can also generate undesirable effects, such as increasing the density and CTE. Therefore, glass-based compositions of one or more embodiments do not comprise these alkalis.

In one or more embodiments, the glass-based composition may include lithium oxide (Li₂O). Without being bound by theory, adding Li₂O to a glass-based composition makes a glass suitable to high-performance ion exchange of lithium ion (Li⁺) for a larger alkali metal ion, such as sodium ion (Na⁺). Since Li⁺ is very small (ionic radius is 0.06 nm), the Li⁺ in the glass can be ion-exchanged very quickly in Na⁺ containing salt bath, and allow to generate compressive stress in short time, and thereby generating a deep DOC in a short time. However, too much Li₂O in the glass can lower glass viscosity and raise glass liquidus temperature, therefore lower the glass liquidus viscosity and cause difficulty for mass production. To achieve good balance between stress profile and ability for manufacturing, it is desirable in embodiments to limit the amount of Li₂O present in the glass-based compositions.

In embodiments, the glass-based composition comprises Li₂O in amounts greater than or equal to 9.0 mol % and less than or equal to 25.0 mol %, such as greater than or equal to 18.5 mol % and less than or equal to 24.5 mol %, greater than or equal to 19.0 mol % and less than or equal to 24.0 mol %, greater than or equal to 19.5 mol % and less than or equal to 23.5 mol %, or greater than or equal to 20.0 mol % and less than or equal to 23.0 mol %, and all ranges and subranges within the disclosed ranges. In one or more embodiments, the glass-based composition comprises greater than or equal to 9.0 mol % and less than or equal to 12.0 mol %, such as greater than or equal to 9.5 mol % and less than or equal to 11.5 mol %, or greater than or equal to 10.0 mol % and less than or equal to 11.0 mol %, and all ranges and subranges within the disclosed ranges.

In embodiments, the glass-based compositions comprise sodium oxide (Na₂O). The amount of Na₂O in the glass-based compositions also relates to the ion exchangeability of the glass made from the glass-based compositions. Specifically, the presence of Na₂O in the glass-based compositions may increase the ion exchange rate during ion exchange strengthening of the glass by increasing the diffusivity of Na⁺ ions through the glass matrix. Also, Na₂O may suppress the crystallization of alumina containing species, such as spodumene, mullite and corundum and, therefore, decrease the liquidus temperature and increase the liquidus viscosity. However, increasing the Na₂O amount in the glass-based compositions may increase CTE and worsen the mechanical properties of glass since it decreases the elastic modulus and the fracture toughness, and/or decrease the annealing and strain points of glass. Accordingly, it is desirable in embodiments to limit the amount of Na₂O present in the glass-based compositions.

In embodiments, the glass-based composition generally comprises Na₂O in an amount greater than or equal to 0.2 mol % and less than or equal to 1.8 mol %. In embodiments, the glass-based composition comprises Na₂O in amounts greater than or equal to 0.3 mol % and less than or equal to 1.6 mol %, such as greater than or equal to 0.4 mol % and less than or equal to 1.4 mol %, greater than or equal to 0.5 mol % and less than or equal to 1.2 mol %, or greater than or equal to 0.6 mol % and less than or equal to 1.0 mol %, and all ranges and subranges within the disclosed ranges.

The glass-based compositions, according to embodiments, may further include potassium oxide (K₂O). The amount of K₂O present in the glass-based compositions also relates to the ion exchangeability of the glass-based composition. Specifically, as the amount of K₂O present in the glass-based composition increases, the compressive stress in the glass obtainable through ion exchange decreases as a result of the exchange of potassium and sodium ions. Also, the potassium oxide, like the sodium oxide, may decrease the liquidus temperature and increase the liquidus viscosity, but at the same time may decrease the elastic modulus and fracture toughness, and may increase CTE. Accordingly, it is desirable to have a limit the amount of K₂O present in the glass-based compositions.

In embodiments, the glass-based composition comprises K₂O in amounts greater than or equal to 0.05 mol % and less than or equal to 1.5 mol %. In one or more embodiments, the glass-based composition comprises K₂O in amounts greater than or equal to 0.1 mol % and less than or equal to 1.4 mol %, such as greater than or equal to 0.2 mol % and less than or equal to 1.3 mol %, greater than or equal to 0.5 mol % and less than or equal to 1.2 mol %, greater than or equal to 0.7 mol % and less than or equal to 1.1 mol %, or greater than or equal to 0.8 mol % and less than or equal to 1.0 mol %, and all ranges and subranges within the disclosed ranges.

Glass-based compositions of embodiments may include titania (TiO₂). Titania can be added to the glass-based composition of the present disclosure to increase the elastic moduli and fracture toughness of glass without significant increase of the density. However, titania may slow down the process of the ion exchange. In addition, a small amount of titania could be added into glass to prevent photo darkening from UV light exposure, which sometime is used in glass cleaning process. However, titania may provide undesirable coloring to the glass. Accordingly, the content of titania is limited in embodiments.

In embodiments, the glass-based composition comprises TiO₂ in amounts greater than or equal to 0.0 mol % and less than or equal to 1.0 mol %. It should be understood that in embodiments the glass-based composition may be free of or substantially free of TiO₂. In one or more embodiments, the glass-based composition comprises TiO₂ in amounts less than or equal to 1.0 mol %, such as less than or equal to 0.5 mol %, less than or equal to 0.2 mol %, or less than or equal to 0.1 mol %, and all ranges and subranges within the disclosed ranges.

Glass-based compositions of embodiments may comprise zirconia (ZrO₂). Zirconia can be added to the glass-based compositions of the present disclosure to increase the elastic moduli, fracture toughness and low-temperature viscosity. However, it was empirically found that adding too much ZrO₂ may increase the liquidus temperature and, therefore, adversely cause crystallization of the refractory minerals, such as zirconia (ZrO₂), zircon (ZrSiO₄) and others, from the glass forming melt at high temperatures. Accordingly, the content of zirconia is limited in embodiments.

In embodiments, the glass-based composition comprises ZrO₂ in amounts greater than or equal to 0.5 mol % and less than or equal to 5.5 mol %. In one or more embodiments, the glass-based composition comprises ZrO₂ in amounts greater than or equal to 1.0 mol % and less than or equal to 5.0 mol %, such as greater than or equal to 1.5 mol % and less than or equal to 4.5 mol %, greater than or equal to 2.0 mol % and less than or equal to 4.0 mol %, or greater than or equal to 2.5 mol % and less than or equal to 3.5 mol %, and all ranges and subranges within the disclosed ranges.

Glass-based compositions of embodiments may include tin oxide (SnO₂). Tin oxide can be added to the glass-based compositions of the present disclosure in small concentrations as a fining agent. However, it was empirically found that in some cases, and especially when the content of Al₂O₃ is greater than or equal to the total content of modifiers, the addition of even very small amounts of SnO₂ may cause precipitation of cassiterite (SnO₂) from the melt at high temperatures. Accordingly, the content of tin oxide is limited in embodiments.

In embodiments, the glass-based composition comprises SnO₂ in amounts greater than or equal to 0.0 mol % and less than or equal to 0.5 mol %. It should be understood that in embodiments the glass-based composition may be free of or substantially free of SnO₂. In one or more embodiments, the glass-based composition comprises SnO₂ in amounts less than or equal to 0.5 mol %, such as less than or equal to 0.4 mol %, less than or equal to 0.3 mol %, less than or equal to 0.2 mol %, or less than or equal to 0.1 mol %, and all ranges and subranges within the disclosed ranges.

Glass-based compositions, according to embodiments, may include phosphorus oxide (P₂O₅). The presence of P₂O₅ increases the liquidus viscosity of the glass-based compositions by suppressing the crystallization of mullite, spodumene, and some other species (e.g., spinel) from the glass-forming melts. However, the content of phosphorus oxide is limited in embodiments.

In embodiments, the amount of P₂O₅ in the glass-based composition is greater than or equal to 0.0 mol % and less than or equal to 2.0 mol %. It should be understood that in embodiments, the glass-based composition is free of or substantially free of P₂O₅. In one or more embodiments, the glass-based composition comprises P₂O₅ in amounts greater than or equal to 0.0 mol % and less than or equal to 2.0 mol %, such as greater than or equal to 0.1 mol % and less than or equal to 1.8 mol %, greater than or equal to 0.2 mol % and less than or equal to 1.5 mol %, greater than or equal to 0.5 mol % and less than or equal to 1.2 mol %, greater than or equal to 0.5 mol % and less than or equal to 1.0 mol %, or greater than or equal to 0.7 mol % and less than or equal to 1.0 mol %, and all ranges and subranges within the disclosed ranges.

In embodiments, the glass-based composition may comprise B₂O₃ in amounts greater than or equal to 4.0 mol % and less than or equal to 8.0 mol %, greater than or equal to 4.5 mol % and less than or equal to 7.5 mol %, greater than or equal to 5.0 mol % and less than or equal to 7.0 mol %, or greater than or equal to 5.5 mol % and less than or equal to 6.5 mol %, and all ranges and subranges within the disclosed ranges. In one or more embodiments, the glass-based article does not comprise B₂O₃.

In embodiments, the glass-based composition may comprise MgO in amounts greater than or equal to 3.0 mol % and less than or equal to 6.0 mol %, such as greater than or equal to 3.5 mol % and less than or equal to 5.5 mol %, or greater than or equal to 4.0 mol % and less than or equal to 5.0 mol %, and all ranges and subranges within the disclosed ranges. In one or more embodiments, the glass-based article does not comprise MgO.

In embodiments, the glass-based composition may comprise CaO in amounts greater than or equal to 0.2 mol % and less than or equal to 1.0 mol %, such as greater than or equal to 0.4 mol % and less than or equal to 0.8 mol %, or greater than or equal to 0.40 mol % and less than or equal to 0.6 mol %, and all ranges and subranges within the disclosed ranges. In one or more embodiments, the glass-based article does not comprise CaO.

Without limiting compositions possibly chosen from each of the various components recited above, in embodiments, the glass-based composition may comprise greater than or equal to 60.0 mol % and less than or equal to 75.0 mol % SiO₂; greater than or equal to 1.0 mol % and less than or equal to 8.0 mol % Al₂O₃; greater than or equal to 18.0 mol % and less than or equal to 25.0 mol % Li₂O; greater than or equal to 0.2 mol % and less than or equal to 1.6 mol % Na₂O; greater than or equal to 0.05 mol % and less than or equal to 1.5 mol % K₂O; greater than or equal to 0.5 mol % and less than or equal to 5.5 mol % ZrO₂; greater than or equal to 0.0 mol % and less than or equal to 2.0 mol % P₂O₅; and greater than or equal to 0.0 mol % and less than or equal to 0.5 mol % SnO₂, and all ranges and subranges within the disclosed ranges.

Without limiting compositions possibly chosen from each of the various components recited above, in embodiments, the glass-based composition may comprise greater than or equal to 62.0 mol % and less than or equal to 72.0 mol % SiO₂; greater than or equal to 2.0 mol % and less than or equal to 6.0 mol % Al₂O₃; greater than or equal to 20.0 mol % and less than or equal to 24.0 mol % Li₂O; greater than or equal to 0.4 mol % and less than or equal to 1.2 mol % Na₂O; greater than or equal to 0.1 mol % and less than or equal to 1.2 mol % K₂O; greater than or equal to 1.5 mol % and less than or equal to 4.0 mol % ZrO₂; greater than or equal to 0.5 mol % and less than or equal to 1.5 mol % P₂O₅; and greater than or equal to 0.0 mol % and less than or equal to 0.5 mol % SnO₂, and all ranges and subranges within the disclosed ranges.

Without limiting compositions possibly chosen from each of the various components recited above, in embodiments, the glass-based composition may comprise greater than or equal to 66.0 mol % and less than or equal to 70.0 mol % SiO₂; greater than or equal to 2.0 mol % and less than or equal to 4.0 mol % Al₂O₃; greater than or equal to 21.0 mol % and less than or equal to 23.0 mol % Li₂O; greater than or equal to 0.5 mol % and less than or equal to 1.0 mol % Na₂O; greater than or equal to 0.5 mol % and less than or equal to 1.1 mol % K₂O; greater than or equal to 2.0 mol % and less than or equal to 3.5 mol % ZrO₂; greater than or equal to 0.7 mol % and less than or equal to 1.1 mol % P₂O₅; and greater than or equal to 0.0 mol % and less than or equal to 0.5 mol % SnO₂, and all ranges and subranges within the disclosed ranges.

Without limiting compositions possibly chosen from each of the various components recited above, in embodiments, the glass-based composition may comprise greater than or equal to 55.0 mol % and less than or equal to 65.0 mol % SiO₂; greater than or equal to 13.0 mol % and less than or equal to 18.0 mol % Al₂O₃; greater than or equal to 8.0 mol % and less than or equal to 12.0 mol % Li₂O; greater than or equal to 1.0 mol % and less than or equal to 2.0 mol % Na₂O; greater than or equal to 0.1 mol % and less than or equal to 0.5 mol % K₂O; greater than or equal to 4.0 mol % and less than or equal to 8.0 mol % B₂O₃; greater than or equal to 3.0 mol % and less than or equal to 5.0 mol % MgO; and greater than or equal to 0.1 mol % and less than or equal to 0.6 mol % CaO, and all ranges and subranges within the disclosed ranges.

Physical properties of lithium aluminosilicate glass-based compositions as disclosed and described herein will now be discussed.

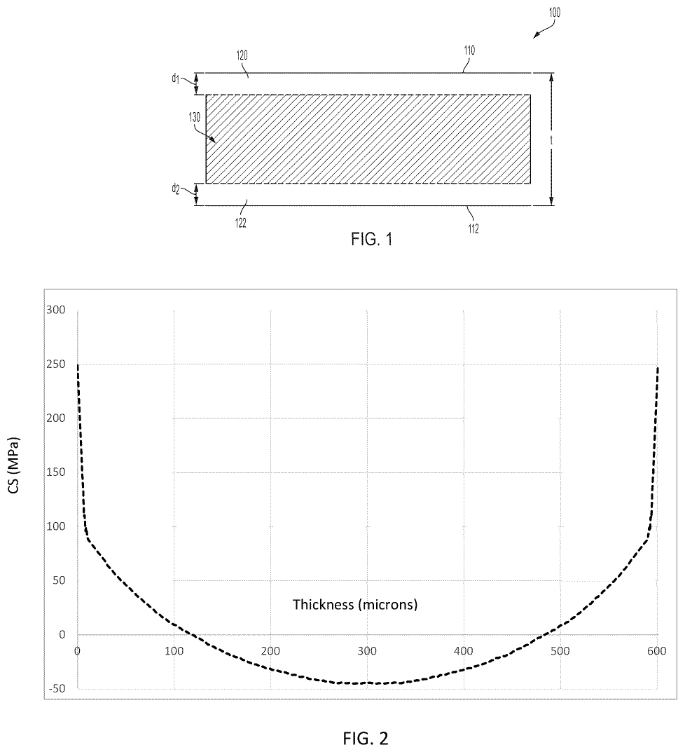

As mentioned above, in embodiments, the alkali aluminosilicate glass-based compositions can be strengthened, such as by ion exchange, making a glass that is damage resistant for applications such as, but not limited to, cover glasses and digital screens. With reference to FIG. 1, the glass has a first region under compressive stress (e.g., first and second compressive layers 120, 122 in FIG. 1) extending from the surface to a depth of layer DOL of the glass and a second region (e.g., central region 130 in FIG. 1) under a tensile stress or central tension CT extending from the depth of layer into the central or interior region of the glass.

“Peak compressive stress,” as used herein, refers to the highest compressive stress (CS) value measured within a compressive stress region. The CS has a maximum at the surface of the glass, and the CS varies with distance d from the surface according to a function. Referring again to FIG. 1, a first segment 120 extends from first surface 110 to a depth d₁ and a second segment 122 extends from second surface 112 to a depth d₂. Together, these segments define a surface compression or surface CS of glass 100. In embodiments, the surface CS may be from greater or equal to 150 MPa and less than or equal to 300 MPa. In embodiments, the surface CS may be at least 150 MPa, at least 220 MPa, at least 240 MPa, at least 250 MPa, at least 260 MPa, or at least 280 MPa. In embodiments, the surface CS may be greater than or equal to 210 MPa and less than or equal to 290 MPa, such as greater than or equal to 220 MPa and less than or equal to 280 MPa, greater than or equal to 230 MPa and less than or equal to 270 MPa, greater than or equal to 240 MPa and less than or equal to 260 MPa, or about 250 MPa.

In embodiments, the compressive stress profile may have a spike in a region near a surface of the glass-based article, such that the compressive stress decreases at a first slope from the surface of the glass-based article to a knee where the slope of the compressive stress transitions to a second slope that is less than the first slope. The point of transition from the first slope to the second slope is referred to herein as the knee of the compressive stress profile. The knee may be present in the within 15 nm of a surface of the glass-based article, such as within 14 nm of a surface of the glass-based article, within 13 nm of a surface of the glass-based article, within 12 nm of a surface of the glass-based article, within 11 nm of a surface of the glass-based article, within 10 nm of a surface of the glass-based article, within 9 nm of a surface of the glass-based article, or within 8 nm of a surface of the glass-based article.

The compressive stress at the knee (CSₖ) of the compressive stress profile is greater than or equal to (20+100*t) MPa, where t is the thickness of the glass-based article in millimeters. In one or more embodiments, the CSₖ of the compressive stress profile is greater than or equal to (25 +100*t) MPa, such as greater than or equal to (30+100*t) MPa, greater than or equal to (35+100*t) MPa, or greater than or equal to (40+100*t) MPa.

Depth of layer″ (DOL), as used herein, refers to the depth within a glass article at which an ion of a metal oxide diffuses into the glass article where the concentration of the ion reaches a minimum value. The depth of layer DOL-after being ion exchanged in a single molten salt for less than 2 hours.

According to one or more embodiments, the central tension (CT) or peak tension (PT) of the glass-based article the CT or PT is less than or equal to 80 MPa, less than or equal to 70 MPa, less than or equal to 60 MPa, less than or equal to 55 MPa, less than or equal to 50 MPa, or less than or equal to 48 MPa. In one or more embodiments, the CT or PT is greater than or equal to 35 MPa, greater than or equal to 40 MPa, or greater than or equal to 44 MPa. Accordingly, in embodiments, the CT or PT is greater than or equal to 35 MPa and less than or equal to 80 MPa, such as greater than or equal to 40 MPa and less than or equal to 70 MPa, greater than or equal to 45 MPa and less than or equal to 65 MPa, or greater than or equal to 50 MPa and less than or equal to 60 MPa.

In one or more embodiments, the depth of compression (DOC) is measured per thickness (t) of the glass-based article (DOC/t) and is greater than or equal to 0.14t, such as greater than or equal 0.15t, greater than or equal to 0.16t, greater than or equal to 0.17t, greater than or equal to 0.18t, greater than or equal to 0.19t, or greater than or equal to 0.20t. In embodiments, the DOC/t is greater than or equal to 0.14t and less than or equal to 0.22t, such as greater than or equal to 0.15t and less than or equal to 0.21t, greater than or equal to 0.16t and less than or equal to 0.20t, greater than or equal to 0.17t and less than or equal to 0.19t.

With the moderate peak tension significantly below the frangibility limit, the glass-based article may tend to fracture with only a single crack extension during fracture events caused by deep damage introduction. Combined with the high fracture toughness of the glass-based articles disclosed and described herein, high DOC, and relatively high CSₖ as described in the inventive examples, this moderate-CT-aspect provides a unique combination of a low probability of fracture and preferred fracture pattern with minimum fragmentation which will in a majority of cases render an electronic device with so-fractured cover glass very much as usable as if the cover glass were not fractured. The QC method based on the one fringe spectrum is very well suited for quality control of this type of product.

In embodiments, the thickness of the glass-based article is less than or equal to 0.74 mm, such as less than or equal to 0.72 mm, less than or equal to 0.70 mm, less than or equal to 0.67 mm, less than or equal to 0.64 mm, less than or equal to 0.62 mm, less than or equal to 0.60 mm, less than or equal to 0.58 mm, less than or equal to 0.56 mm, less than or equal to 0.54 mm, less than or equal to 0.52 mm, less than or equal to 0.50 mm, less than or equal to 0.48 mm, less than or equal to 0.46 mm, or less than or equal to 0.43 mm. For each of the above values, the thickness of the glass-based article is greater than or equal to 0.35 mm.

According to embodiments, glass-based articles have a fracture toughness of the mid-plane composition of the glass-based article is greater than or equal 0.75 MPα\sqrt{m}, such as greater than or equal to 0.80 MPα\sqrt{m}, greater than or equal to 0.85 MPα\sqrt{m}, greater than or equal to 0.90 MPα\sqrt{m}, greater than or equal to 0.95 MPα\sqrt{m}, greater than or equal to 1.00 MPα\sqrt{m}, greater than or equal to 1.10 MPα\sqrt{m}. In one or more embodiments, glass-based articles have a fracture toughness of the mid-plane composition of the glass-based article is greater than or equal to 0.75 MPα\sqrt{m} and less than or equal to 1.50 MPα\sqrt{m}, such as greater than or equal to 0.80 MPα\sqrt{m} and less than or equal to 1.45 MPα\sqrt{m}, greater than or equal to 0.85 MPα\sqrt{m} and less than or equal to 1.40 MPα\sqrt{m}, greater than or equal to 0.90 MPα\sqrt{m} and less than or equal to 1.35 MPα\sqrt{m}, greater than or equal to 0.95 MPα\sqrt{m} and less than or equal to 1.30 MPα\sqrt{m}, greater than or equal to 1.00 MPα\sqrt{m} and less than or equal to 1.25 MPα\sqrt{m}, or greater than or equal to 1.10 MPα\sqrt{m} and less than or equal to 1.20 MPα\sqrt{m}.

As noted above, compressive stress layers may be formed in the glass-based articles by exposing the glass-based composition to an ion exchange solution. In embodiments, the ion exchange solution may be molten nitrate salts or molten sulfate salts. In embodiments, the ion exchange solution may be molten KNO₃, molten NaNO₃, molten LiNO₃, or combinations thereof. In certain embodiments, the ion exchange solution may comprise greater than or equal to 15 wt % and less than or equal to 40 wt % molten NaNO₃, greater than or equal to 0.020 wt % and less than or equal to 0.5 LiNO₃, and greater than or equal to 59 wt % and less than or equal to 85 wt % molten KNO₃. In one or more embodiments, the ion exchange solution comprises greater than or equal to 12 wt % and less than or equal to 30 wt % NaNO₃, greater than or equal to 0.02 wt % and less than or equal to 0.1 wt % LiNO₃, and greater than or equal to 75 wt % and less than or equal to 80 wt % KNO₃.

The glass-based composition may be exposed to the ion exchange solution by dipping a glass article made from the glass-based composition into a bath of the ion exchange solution, spraying the ion exchange solution onto a glass article made from the glass-based composition, or otherwise physically applying the ion exchange solution to a glass article made from the glass-based composition. Upon exposure to the glass-based composition, the ion exchange solution may, according to embodiments, be at a temperature from greater than or equal to 450° C. to less than or equal to 550° C., such as from greater than or equal to 470° C. to less than or equal to 515° C., or from greater than or equal to 475° C. to less than or equal to 500° C. In embodiments, the glass-based composition may be exposed to the ion exchange solution for a duration from greater than or equal to 7 minutes to less than or equal to 210 minutes, such as from greater than or equal to 45 minutes to less than or equal to 160 minutes, from greater than or equal to 60 minutes to less than or equal to 150 minutes, from greater than or equal to 80 minutes to less than or equal to 140 minutes, or from greater than or equal to 100 minutes and less than or equal to 120 minutes.

Glass-based articles according to embodiments disclosed and described herein may have a compressive stress profiles as shown in FIG. 2 with a spike region extending from the surface of the glass-based article to a depth of about 10 μm and a compressive stress at the knee (CSₖ) of about 90 MPa. The DOC is about 120 μm, and the CT or PT is about 48 MPa at a depth of about 300 μm. It should be understood that FIG. 2 is merely an exemplary stress profile for glass-based articles according to embodiments disclosed and described herein, and the values shown may be different for various embodiments disclosed and described herein.

The properties of the glass-based articles described above are sufficient for glass-based articles that may be used as glass covers for electronic devices. However, traditional quality control measurements to ensure that glass-based articles have the above properties can be costly and time consuming. However, it has been found that forming glass-based articles to have the properties described above allows for quality control measurements that are quick and less costly than traditional quality control measurements. Accordingly, forming glass-based articles to have the glass-based composition disclosed herein and strengthening the glass-based article by ion exchange process as disclosed herein provides glass-based articles that can take advantage of the quality control measurement techniques described below.

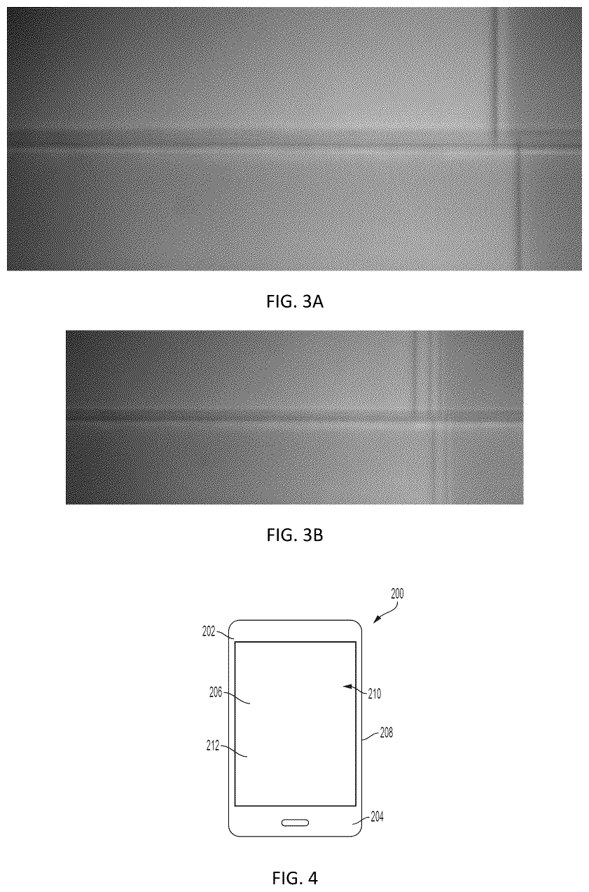

FIG. 3A shows an exemplary prism coupling spectrum of glass-based articles according to embodiments disclosed and described herein and depicts a single guided mode in the prism coupling spectrum at a wavelength between 360 nm and 405 nm for at least one of the transverse-magnetic or transverse-electric polarization, also referred to herein as a “1-fringe spectrum,” and indicates a glass-based article having the desired properties disclosed and described herein. In embodiments, the glass-based articles may have a single guided mode in the prism coupling spectrum at a wavelength between 360 nm and 405 nm for both the transverse-magnetic and transverse-electric polarization. In contrast, FIG. 3B shows a multi-fringe prism coupling spectrum, which indicates that the glass-based article does not have the desired properties disclosed and described herein.

The 1-fringe spectrum has unique advantages for quality-control of transparent glass ceramics that go beyond the selection of near-optimum ion-exchange time for certain thicknesses. Compared to conventional chemically-strengthened glass-ceramics which do not exhibit a strongly-guided optical mode, the 1-fringe spectrum offers multiple parameters for quality control which allows to avoid the need for direct tension-zone measurement through scattered-light polarimetry which is slower and more expensive, and also poorly suited for glasses and glass-ceramics having low thickness and/or moderate peak tension, such as 60 MPa or lower. On the other hand, compared to glass-ceramic articles ion-exchanged to exhibit two or more fringes per polarization, the one-fringe spectrum offers a significantly wider measurement window, allowing for accurate CSₖ measurement for a wide range of ion-exchange conditions. This turns out to be essential for the best glass-ceramics having significant crystalline content (e.g., similar, higher, or significantly higher than the glass-phase content by volume) because it is very difficult to raise the K-concentration in these materials enough to allow significant separation of the fringes. Since the size of the proper measurement window for CSₖ measurements increases with the increase of the fringe separation, it is practically impossible to have an adequate measurement window in tough glass-ceramics with high fraction of the crystalline phase. The present inventors have recognized this problem and found an effective solution by defining a target 1-fringe spectrum and designing quality-control architecture that allows effective quality control of the chemical strengthening and the resulting stress profile, at low cost, and without QC-metrology-imposed artificial yield-loss (e.g., due to problematically narrow measurement window).

In embodiments, the spacing between the one guided mode and the critical angle is greater than or equal to 0.00012 refractive-index units (RIU) for at least one of the TM and TE polarizations, such as greater than or equal to 0.00020 RIU for at least one of the TM and TE polarizations, greater than or equal to 0.00025 RIU for at least one of the TM and TE polarizations, greater than or equal to 0.00030 RIU for at least one of the TM and TE polarizations, or greater than or equal to 0.00035 RIU for at least one of the TM and TE polarizations. In one or more embodiments, the spacing between the one guided mode and the critical angle is greater than or equal to 0.00012 RIU for both the TM and TE polarizations and greater than or equal to 0.00020 RIU for at least one of the TM or TE polarizations, such as greater than or equal to 0.00012 RIU for both the TM and TE polarizations and greater than or equal to 0.00025 RIU for at least one of the TM or TE polarizations, or greater than or equal to 0.00012 RIU for both the TM and TE polarizations and greater than or equal to 0.00030 RIU for at least one of the TM or TE polarizations.

The glass-based articles made from the glass-based compositions disclosed herein may be incorporated into another article, for example an article with a display (or display articles) (e.g., consumer electronics, including mobile phones, watches, tablets, computers, navigation systems, and the like), architectural articles, transportation articles (e.g., automobiles, trains, aircraft, sea craft, etc.), appliance articles, or any article that may benefit from some transparency, scratch-resistance, abrasion resistance or a combination thereof.

An exemplary article incorporating any of the glass-based articles disclosed herein is shown in FIG. 4. Specifically, FIG. 4 shows a consumer electronic product 200 including a housing 202 having a front surface 204, a back surface 206, and side surfaces 208. A display 210, for example, a light emitting diode (LED) display or an organic light emitting diode (OLED) display, is at least partially inside the housing 202. A cover substrate 212 may be disposed at or over front surface 204 of housing 202 such that it is disposed over display 210. Cover substrate 212 may include any of the glass-based articles made from the glass-based compositions disclosed herein. Cover substrate 212 may serve to protect display 210 and other components of consumer electronic product 200 from damage. In embodiments, cover substrate 212 may be bonded to display 210 with an adhesive. In embodiments, cover substrate 212 may define all or a portion of front surface 204 of housing 202. In some embodiments, cover substrate 212 may define front surface 204 of housing 202 and all or a portion of side surfaces 208 of housing 202.

It should be understood that in embodiments, the glass-based article may be a 2-dimensional (2D) glass-based article, a 2.5-dimensional (2.5D) glass-based article, or a 3-dimensional (3D) glass-based article. As used herein, a 2D glass-based article is a glass-based article that has major surfaces that are essentially flat, meaning that the thickness of the glass-based article does not vary significantly across the surface of the glass-based article and the glass-based article does not have significant curvature. In 2D glass-based articles, the edges of the glass-based articles are approximately at 90° angles to the major surfaces of the glass-based articles. In contrast, 2.5D glass-based articles have a reduced thickness and/or slight curvature at one or more edges of the glass-based article. In 2.5D glass-based articles, most of the major surfaces has a uniform thickness and do not have any curvature, however at the edges (for example within a tens of microns from the edge), the thickness of the glass-based article decreases and/or the glass-based article has a sudden curvature. In embodiments, 2.5D glass-based articles can be perceived as glass-based articles having rounded edges. In addition, 3D glass-based articles has a noticeable change in thickness and/or curvature along the major surface of the glass-based article. In embodiments, the curvature may be pronounced near the edges of the glass-based article, but the curvature is significantly more pronounced than 2.5D glass-based articles. In embodiments, 3D glass-based articles include glass-based articles with wrap-around edges or glass-based articles used in covers of curved screens.

### EXAMPLES

Embodiments will be further clarified by the following examples. It should be understood that these examples are not limiting to the embodiments described above.

Glass-based compositions according to Table 1 were subjected to ion-exchange processes as disclosed in the examples provided below.

TABLE 1

| | | Range |
|---|---|---|
| Component | Mol % | (mol %) |
| SiO₂ | 70.26 | 70-70.5 |
| Al₂O₃ | 4.24 | 4-4.5 |
| Li₂O | 21.25 | 20.5-22.5 |
| Na₂O | 1.46 | 1.3-1.6 |
| K₂O | 0.13 | 0.05-0.25 |
| ZrO₂ | 1.72 | 1.5-2.0 |
| P₂O₅ | 0.90 | 0.8-1.0 |
| SnO₂ | 0.02 | |

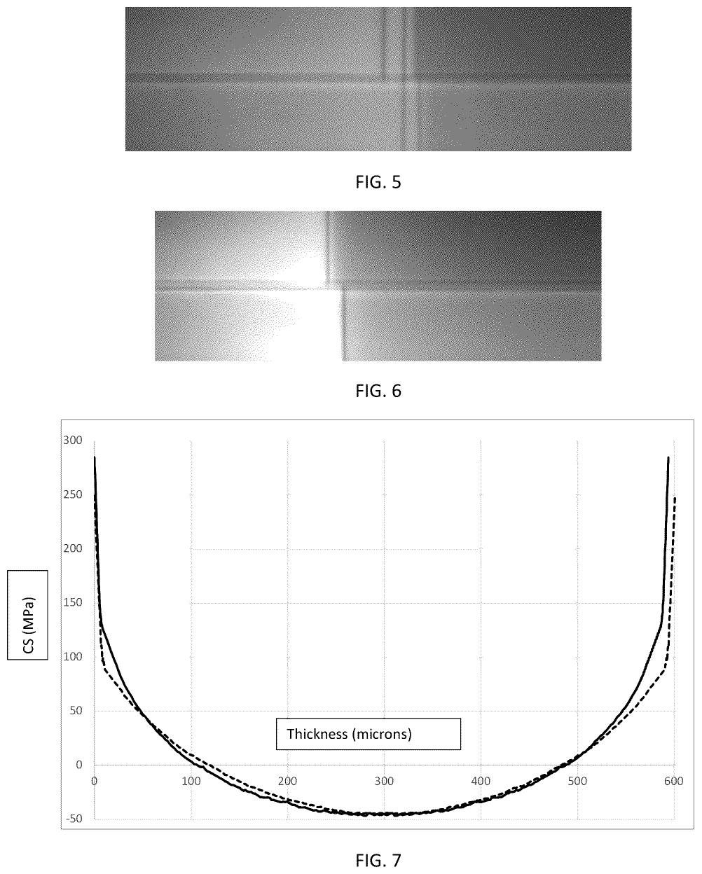

FIG. 5 shows 365-nm prism-coupling spectrum (FSM) measured on a specimen of 0.6-mm-thick glass-ceramic having a composition as shown in Table 1, ion exchanged at 530° C. for 140 min in a salt bath comprising 20 wt % NaNO₃, 0.1 wt % LiNO₃, and 79.9 wt % KNO₃, with additive of 1% silicic acid. In a face-drop testing as the cover-glass on a testing vehicle with mass 200 g on 80-grit Rynowet sandpaper, the failure height averaged 72 cm, with the full range of the 10 systems tested spanning from 40 cm to 90 cm. Said average failure height was about 2.5 times higher than that for test samples equipped with 0.6-mm-thick Gorilla® glass Victus® cover glass, and about 2.2 times higher than that for test vehicles equipped with Gorilla® glass Victus® 2 cover glass.

FIG. 6 shows a prism-coupling spectrum at 365 nm for specimen of 0.6-mm-thick glass-ceramic having the composition disclosed in Table 1, ion exchanged at 470° C. for 160 min in a salt bath comprising 40 wt % NaNO₃, 0.1 wt % LiNO₃, and 59.9 wt % KNO₃. When used on 200 g drop-testing sample in the same 80-grit sandpaper-drop test, 9 devices showed average height-to-failure of 96 cm, with the results spanning the range form 40 cm to 170 cm. Said average height-to-failure was about 3.3 times higher than the average height-to-failure for equivalent systems equipped with Gorilla® glass Victus® cover glass, and about 2.9 times higher than the average height-to-failure for systems equipped with Gorilla® glass Victus® 2 glass.

FIG. 7 shows the stress profiles for 0.6-mm glass ceramic having the composition shown in Table 1 ion exchanged according to the conditions represented by the prism-coupling spectra of FIG. 5 and FIG. 6. The near-surface CS-spike is only approximately accurate, because of the limited optical resolution of RNF (about 1.5-2 microns). The surface compressive stress is extrapolated to correct for the finite resolution, and the extrapolation results in uncertainty in the displayed surface CS on the order of 20-50 MPa, most often under-estimating the surface CS. The profile on the inside the glass beyond the surface spike can be considered substantially accurate, with minor uncertainty in the closest vicinity of the knee point (nearest 10 microns) where the CS may be slightly under-estimated as a result of LOESS smoothing applied to the raw RNF data to reduce the noise in the profiles. The continuous profile representing the condition of FIG. 2 has higher CSₖ of about 135 MPa, compared to 85 MPa for the dashed-line profile corresponding to the ion-exchange condition represented by the spectrum of FIG. 5. The DOC for the profile of the example of FIG. 6 is slightly smaller, in small part due to 1% smaller thickness. It was observed that the higher CSₖ of the profile corresponding to the condition of FIG. 2 correlates with somewhat higher average height-to-failure. It should be noted that for a single-step ion-exchange process, surface CS and CSₖ generally reduce with increased amount of ion exchange, which amount is increased though longer ion-exchange time, higher ion-exchange temperature, or both. Specifically for the examples of FIGS. 4, 5, and 6, the 140 min exchange at 530° C. for the example of FIG. 5 is equivalent to nearly tripling the ion-exchange time of the condition of FIG. 6 (which time is 160 min but at a substantially lower temperature of 470° C.).

The examples illustrated in FIGS. 4, 5, and 6, demonstrate very significant increase in drop-fracture resistance compared to state-of-the-art chemically strengthened glass, approaching close to the performance of the best glass ceramics, particularly for the example of FIG. 2. The state-of-the-art lithium-containing glass ceramics, on the other hand, have much higher center tension (100-160 MPa), and require quality control though integrated stress meters such as ISM-100, which measure both the surface stress and also directly measure the tension zone, to ensure the profile has adequate DOC and CT, and at the same time the CT is within specification and the glass-ceramic is non-frangible. The substantially lower CT for the glass-based articles disclosed and described herein do not require frangibility control because it is much lower than the frangibility limit. In addition, at small thicknesses below 0.7 mm, directly measuring the CT of a glass ceramic by scattered-light polarimetry with precision finer than 2 MPa is difficult, which presents a challenge when trying to quality control product with a specification between 44 MPa as a lower-spec limit and 53 MPa as an upper-spec limit, because the uncertainty of the measurement is not many times smaller than the specification range. This is unlike the high-CT glass-ceramics where the absolute size of the CT specification range window is much wider. The high fracture resistance of the examples of FIG. 5 and FIG. 6 featuring high fracture toughness and moderate amounts of residual stress form chemical strengthening presents an opportunity to bring to market a high-performing product at reduced cost, wherein the cost reduction is the result of a combination of faster ion exchange, less frequent poisoning control of the ion-exchange bath, and simplified quality control that does not require purchasing state-of-the-art integrated-stress meters. The example of FIG. 1 utilizes FSM-only measurements for quality control (QC). These are fast measurements, usually 2 seconds per measurement, generally faster than measurements with integrated stress meters. Compared to state-of-the-art glass ceramics, the ion exchange of 140 min at 530° C. represents reduced ion-exchange time on the order of a factor of 2. The bath poisoning per run is also smaller by a factor exceeding 1.5. The quality control in this example relies on an FSM spectrum featuring 2 fringes in each of the transverse-magnetic (upper half of the image) and transverse electric (lower half of the image) spectrum, and clearly separated critical-angle transitions that allow the direct measurement of the knee stress CSₖ. The quality control establishes that ion exchange was done of both K-ions and Na-ions into the glass, by observing that the surface spike has the required 2 fringes per polarization, and the CSR is positive. The fringe pattern allows to calculate surface CS and depth of the spike (DOLₛₚ). When DOLₛₚ is within the specified range, then it is proven that the amount of diffusion was appropriate. Then, if surface CS and CSₖ are within their specified ranges, this guarantees that the total amount of stress in the profile is on-target, and accounting that the amount of diffusion is appropriate, it is verified that the CT is on target and the DOC is also on target. This quality-control method is well understood and works very well when the target stress profile is not too close to the frangibility limit. One limitation of example 1 is that the length of ion-exchange diffusion had to be extended significantly to reach the 2-fringe requirement for the quality control. In particular, the diffusion time of 140 min at 530° C. was more than twice the time needed to reach the maximum CT for the ALD-GC when exchanged in a bath with the composition 20 wt % NaNO₃/0.1 wt % LiNO₃/79.9 wt % KNO₃. Hence, the CS_{K} and the total stress in the profile were reduced unnecessarily by ion exchanging too long. The DOC does not suffer from extending ion exchange beyond the maximum-CT point, but the CSk and surface CS do decrease, as does the integral of compressive stress from the surface to the DOC. In addition, each ion exchange run produces about 40-50% more LiNO₃ than runs restricted to about the max-CT point, which requires more frequent addition of lithium-capture compounds such as tri-sodium-phosphate (TSP), which results in more frequent down-time for the ion-exchange equipment, as well as more frequent need to empty the bath to clean the accumulated sludge comprising phosphate and silicic acid. Furthermore, the required temperature of 530° C. (to speed up the K-diffusion), is only possible in special types of ion-exchange equipment that is more corrosion resistant and generally designed for higher temperature operation. Furthermore, salt decomposition rates increase dramatically with temperature above 470° C., requiring more frequent additions of silicic acid to compensate pH drift resulting from the decomposition (the higher the temperature, the more frequent the bath treatments need to be). Finally, at higher temperatures, the effectiveness of TSP to eliminate Li from the liquid phase of the molten salt decreases, so larger quantities of TSP are needed for the elimination of a unit of Li poisoning, which leads to faster accumulation of sludge that requires more frequent shutdowns to preform salt-tank cleaning. Such shutdowns are relatively expensive, as equipment downtime extends for several days, and new salt needs to be melted, which also costs significant amount of energy and CO₂ emissions. While the example of FIG. 1 is better than state-of-the art glass-ceramics on the aspects of bath poisoning, energy use, and ion-exchange time, the example of FIG. 2 is significantly better.

Unlike the example of FIG. 5, the example of FIG. 6 does not go beyond the maximum-CT point. Not only does that result in cost savings, but also is providing somewhat better fracture-resistance owing to higher CSₖ. The example of FIG. 6 has one fringe in each of the upper and lower spectrum, wherein only in the upper (TM) spectrum is the fringe well separated from the nearby critical-angle transition. The present inventors have found this example spectrum suitable for approximate quality control as follows: The spacing between the upper fringe and its transition can be measured and required to be in a specific range, along with the spacing between the upper and lower fringe. As long as both spacings are in range, then if the ion exchange bath had approximately the correct ratio of NaNO₃ to KNO₃, then it is established that the glass has surface CS and CSₖ approximately in range, and the separation of the upper fringe form the transition establishes that approximately the correct length of diffusion has taken place, therefore the DOC and CT are within the desired range. While this type of QC is not very precise, it is still low-cost and fast, based on existing equipment, and only requiring a new QC algorithm to be implemented and utilized, based on existing image processing but new interpretation procedures. Due to the small spacing between the upper fringe and the transition, the process window may be somewhat limited (e.g., moderate downward deviations of KNO₃ concentration and/or temperature could result in product that cannot be measured and passed), but with reasonably strict control of temperature and salt ratio KNO₃: NaNO₃, a product could be made and quality controlled with FSM-spectrum similar to that of example 2.

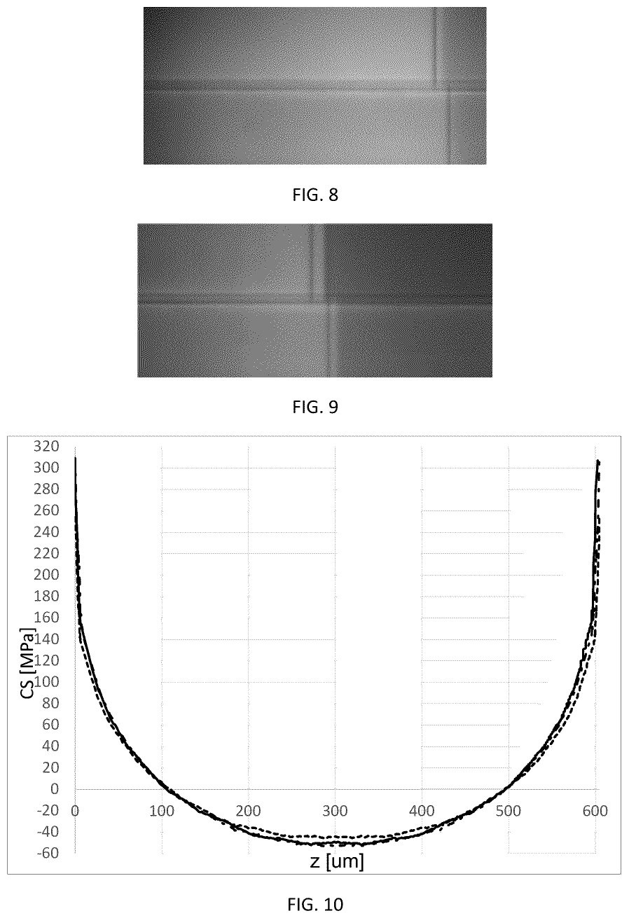

FIG. 8 shows a prism-coupling spectrum at 365 nm for 0.6-mm-thick 3D-formed glass-based article having a composition as shown in Table 1 ion-exchanged in 40 wt % NaNO₃, 0.1 wt % LiNO₃, and 59.9 wt % KNO₃ at 470° C. for 160 minutes. This is another example of a spectrum that allows approximate quality control by use of the spacing between the upper and lower fringe, and the spacing between the upper fringe and its transition. In this example, similar to the example of FIG. 6, the ion exchange is in the optimum range for diffusion length, in that the ion exchange time is close to the time for maximum CT.

FIG. 9 shows a prism-coupling spectrum at 365 nm for 0.6 mm-thick 2D glass-based article having the composition as disclosed in Table 1 ion-exchanged in a bath of 25 wt % NaNO₃, 0.05 wt % LiNO₃, and 74.95 wt % KNO₃, at 500° C. for 90 minutes. This illustrates an embodiment, wherein the bath composition and temperature are chosen such that at an optimum time for maximizing the product CT*TA (where TA is the tension area, e.g., the depth-integral of tensile stress in the interior of the sheet), the prism-coupling spectrum is in a preferred condition of having one upper and one lower fringe, each separated significantly from the transition, allowing measuring several parameters with high relative precision. Said parameters comprise the spacing between the upper and the lower fringe, the spacing between the upper and lower transition for direct measurement of CSₖ, and the spacings between the upper fringe and its transition and the lower fringe and its transition. High relative precision means that for each such parameter, the uncertainty of a measurement is significantly smaller than the nominal target value of the parameter. For example, the uncertainty in the spacing between a fringe and its transition needs to be significantly smaller than said spacing itself, to allow precise measurements for quality-control purposes. FIG. 9 also illustrates an edge of the preferred 1-fringe measurement window, in that a leaky mode is forming in the upper (TM) spectrum, and any increase in the ion-exchange time would lead to a shift in the apparent position of the transition at 365 nm driven by the leaky mode, and an over-estimation of the CSₖ. Hence, for this particular example, it would be better to choose a slightly longer wavelength such as 385 nm or 405 nm, so as to eliminate the proximity of a leaky mode to the critical angle, and avoid systematic errors associated with the leaky mode.

FIG. 10 compares the compressive-stress profiles for ceramic glass-sheet articles according the composition of Table 1 ion exchanged according to the conditions for FIG. 8 (dash-dotted) and FIG. 9 (continuous), compared to the profile of drop-test article prepared according to conditions for FIG. 6. It shows that it is possible to obtain substantially identical profiles at the depths beyond the surface-spike depth DOLₛₚ, using different baths, temperatures, and ion-exchange times. The condition associated with FIG. 5 is most preferred for precise quality control, because it allows controlling more parameters with higher precision, most importantly, directly measuring CSₖ. The ability to measure and control 4 substantially independent parameters instead of only 2 allows for strict quality control, rather than approximate. It further allows early detection of drifts such as bath composition and temperature.

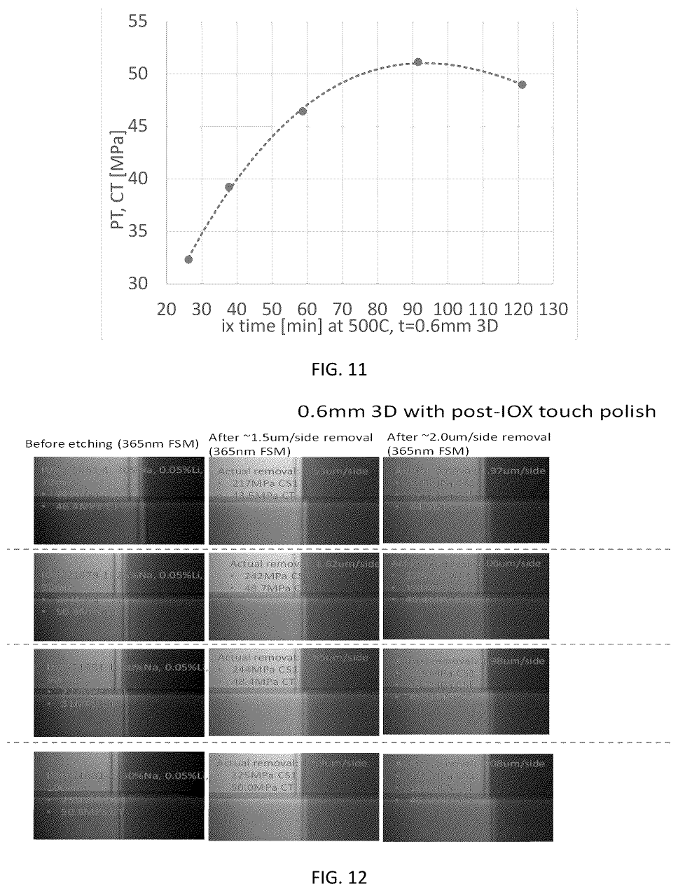

FIG. 11 shows the center tension of a 0.6-mm sheet of glass-ceramic having a composition as disclosed and described herein which has undergone 3D-forming thermal cycle following the normal ceramming process. The maximum of peak tension PT (or center tension CT when the stress-profile is symmetric) occurs for ion-exchange time of about 92 minutes at 500° C. The ion-exchange salt contained about 20 wt % NaNO₃, 0.05 wt % LiNO₃, and 79.95 wt % KNO₃, with added silicic acid of 1% by weight. The LiNO₃ was added intentionally to help preventing devitrification of the ceramic phase near the surface during ion exchange. Usually the stress profile contains the highest stress-integral at times somewhat shorter than the max-CT time, and the depth of compression is substantially stabilized near its maximum value by the max-CT time. Ion exchange significantly past the max-CT time leads to reduction in the stress integral, which usually hurts fracture resistance, and increase in cost due to lower utilization of ion-exchange equipment and personnel, increased bath poisoning, and increased energy usage. In a majority of cases, it would be preferable to use ion-exchange time that is between 50% and 130% of the max-CT time, further preferable between about 60% and 120% of the max-CT time, and ideally between 70% and 105% the max-CT time. In some cases (such as thicker glass for watch covers, for example 1.1 mm watch, the preferred stress profile does not have maximum CT or maximum DOC, but rather, adequate DOC, adequate surface CS, adequate depth of the spike DOL_{K}, and adequate knee-stress CS_{K}. This is because it is rarely necessary for the DOC to exceed about 160 μm, and for a 1.1 mm watch that is substantially less than the maximum DOC that can be obtained with standard ion-exchange techniques for Li-based glasses. One of the purposes of quality-control measurements on the ion-exchange parts is to establish that the specimen properties are consistent with chemical strengthening within the target range of conditions, which is usually the preferred range for maximum performance with the associated minimum required cost.

In the case of 0.4 to 0.7 mm phone covers, it is usually preferable to operate near the max-CT point. In the case of watch-cover glass, it may be preferable to operate near a point where the stress profile has a surface spike that is 5-8 μm deep, a DOC that higher than 160 μm but need not be higher than 180 μm, and CSk that is at least 150 MPa. In the case of the glass ceramics according to the composition of Table 1, and at least some more transparent glass-ceramics, it is possible to meet these preferred requirements and perform effective quality control when the article is designed to feature a 1-fringe potassium-based surface spike when measured on prism-coupling instrument at 365 nm (or more generally, at a wavelength of 405 nm or less, preferably below 385 nm or 375 nm). The time to max CT does depend on the thermal history of the glass or glass ceramic. In the case of ALD glass ceramic, without the post-ceram 3D-forming thermal treatment, the time to max-CT at 0.6 mm is about 130 to 135 min, about 45% longer than the max-CT time for the 3D-formed ALD glass ceramic. It should be noted that in the case of 3D-forming of fusion glasses it is usually the case that the time to max-CT is higher for the 3D-formed glass due to slower cooling following the 3D-forming when compared to the cooling in the fusion-draw process.

A property of the article that allows effective quality control is not inherent. Rather, for most accurate control, it is preferred that the one fringe corresponding to a guided optical mode be adequately separated from the critical-angle transition, so as to allow precise determination of the critical angle, the fringe position, and the distance between the fringe and the critical angle. This is because said distance is a quality-control variable, and the relative precision of the measurement of that variable needs to be fine enough to allow for normal process variation to be tracked, and allow for the quality-control measurement window to be wide enough to allow normal production without unnecessary yield-loss due to false-positive out-of-specification results.

It should also be understood that the time to max CT scales as the square of the thickness of the specimens. Hence, in the case of normal roller-made glass-based articles having the composition disclosed in Table 1, the time to max CT is about 1 hour for 0.4 mm, about 94 minutes for 0.5 mm, and about 135 min for 0.6 mm, while for a specific 3D-forming thermal cycle used in some of the examples of this disclosure, the max-CT time is about 92 min for 0.6 mm, and would be about 41 min for 0.4 mm and 64 min for 0.5 mm.

FIG. 12 shows prism-coupling spectra taken at 365 nm for 0.6-mm glass-based article having the composition of Table 1 ion exchanged at 500° C. in three different nitrate-salt-mixture baths having different ratios of NaNO₃ to KNO₃. The NaNO₃ content of the baths is 20 wt %, 25 wt %, and 30 wt %, respectively. The baths also contain 0.05 wt % of LiNO₃ by weight, and the rest of the salt is KNO₃. The first row of images corresponds to ion exchange for 70 minutes in the bath containing 20 wt % NaNO₃. The second row of images corresponds to ion exchange for 90 minutes in the bath containing 25 wt % NaNO₃. The third and fourth row correspond to ion exchange for 90 min and 100 min, respectively, in the bath containing 30 wt % NaNO₃. In each row, the first image represents the ion-exchange article without any removal of material from the surface. The second image in each row corresponds targeted material removal of about 1.5 micron per surface, by polishing or etching. In practice, the material removal was done by etching, and in some cases it exceeded 1.5 micron and was closer to 1.6 micron. The third image in each row corresponds to target removal of about 2 microns per surface. Post-ion-exchange fine polish is often an integral part of the finishing of the chemically strengthened glass articles, due to its effectiveness to remove small blemishes and shallow flaws, which are problematic either for the appearance or for the surface strength of the glass article. The prism-coupling spectra of FIG. 12 combined with the ion-exchanged conditions illustrate several examples of how product with required levels of surface CS and knee-stress CSₖ can be quality controlled before and after polish. In particular, the final spectrum after polish preferably has a single fringe in each polarization state (the upper portion of the image shows the transverse-magnetic or TM polarization state, the lower shows the transverse-electric or TE). The knee stress as usual is measured by dividing the critical-angle birefringence by the stress-optic coefficient (SOC), and the critical-angle effective index corresponds to the location of maximum slope on the transition between total internal reflection and partial reflection, to the right of the single fringe in the example images. Furthermore, in these examples the surface compressive stress CS_{surf} is generally larger than the quality-control parameter CS₁ introduced here as the ratio of the birefringence of the first fringe (the only fringe in the case of 1-fringe spectra) and the SOC:

$${CS}_{surf} \geq \frac{{CS}_{1}}{SOC} ≡ \frac{{n}_{0}^{eff} ( TM ) - {n}_{0}^{eff} ( TE )}{SOC}$$

Where n₀^{eff} stands for the effective index of the lowest-order mode, and mode count starts from 0.

Quality control based on prism-coupling measurements can be implemented both before and after polish. Before polish there maybe 2 fringes in at least one of the polarizations, which allows to measure the depth of the K-spike, as well as the index increment due to K-ions in that one polarization. If there are also 2 fringes in the other polarization state, then surface CS can be calculated using formulas known in the art and commercially available with different quality-control software suites.

The general trend of FIG. 12 is that when more significant polish is required, then longer ion-exchange time would be required, or the bath will need to have lower ratio NaNO₃ to KNO₃ to allow faster formation of a 2-fringe spectrum to allow extra K-DOL for polishing. For example, the bath with 20 wt % NaNO₃ can accommodate 2 microns of polish after only 70-min ion exchange. Since 70 min is significantly before the time for maximum CT at 0.6 mm thickness, the CT of the specimens exchanged for longer times in the baths having higher levels of NaNO₃ are higher. All three baths can deliver good stress profiles that can be quality-controlled using prism coupling measurements after polish, where the higher-Na baths (25 to 30 wt % NaNO₃) are better suited for cases where the required polish is on the lower side (like 1.5-2 microns), and the lower-Na baths (20 to 25 wt % NaNO₃) are better suited for cases where the required polish is greater than 2 microns.

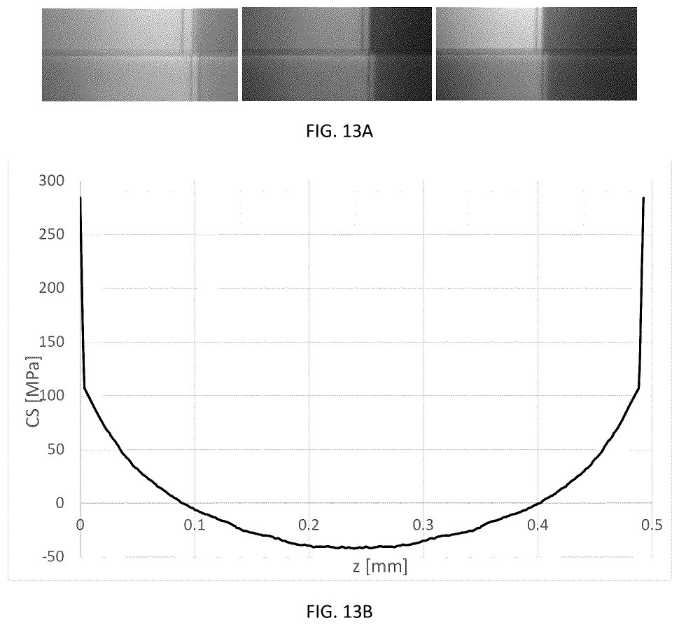

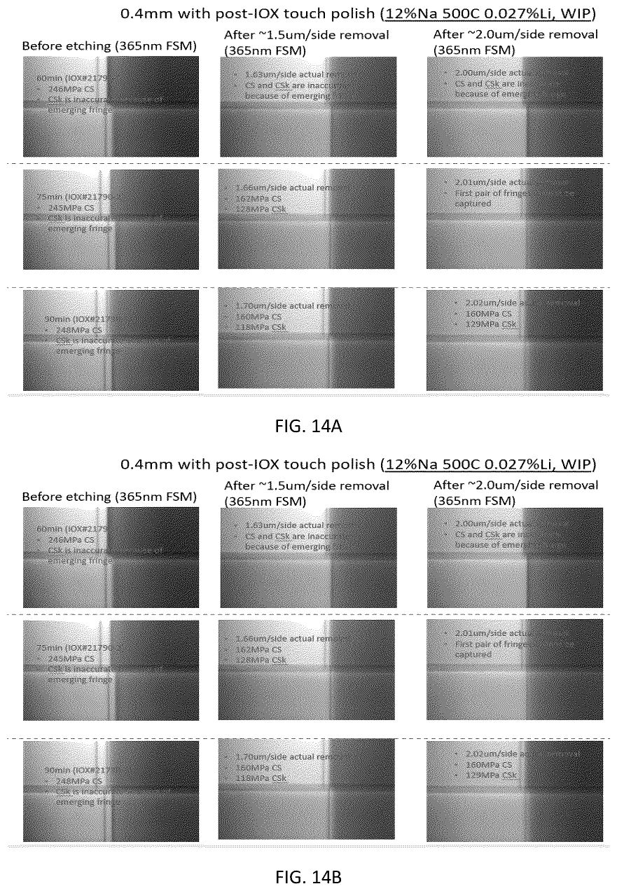

A specimen of glass ceramic having a composition as shown in Table 1, wherein the material has been cerammed but has not undergone 3D-forming treatment, has been ion exchanged at 500° C. for 100 min in a bath mixture with about 15 wt % NaNO₃ and 85 wt % KNO₃ by weight, also containing about 0.033 wt % LiNO₃ to prevent low-index layer formation by devitrification of the nano-crystals. The 365-nm prism-coupling spectrum is shown in FIG. 13A, featuring 2 fringes in each polarization state in the spectrum before polish, and 1-fringe spectra after 1.33 micron (middle image) and 1.94-μm material removal per side. CSₖ readings from the images include 135 MPa after 1.33-μm removal, and 125 MPa after 1.94-μm removal. Prism-coupling measurements of CSₖ can have uncertainty as much as 10 MPa. After removal of 1.33 to 2 microns of material on each side of the glass-ceramic sheet, the spectrum becomes 1-fringe, and the quality control parameters that are used are the CSₖ, CS₁, and the distances between each fringe and its corresponding critical-angle transition. The stress profile after the polish is shown in FIG. 13B, said stress profile obtained by the RNF technique. The stress profile features a DOC of 89 micron, about 18% of the thickness of 0.49 mm, a peak tension PT of about 41.5 MPa, stress-area of the tension zone (e.g., tension area TA) of about 8.65 MPa*mm, which represents about 17.6 MPa when normalized to the specimen thickness. The knee stress is about 120 MPa according to the profile.

FIG. 14A and FIG. 14B present another embodiment. FIG. 14A shows prism-coupling spectra at 365 nm for specimens of glass ceramic having the composition as disclosed in Table 1 with thickness of about 0.4 mm ion exchanged at 500° C. in a bath having about 12 wt % NaNO₃ and about 88 wt % KNO₃, also having a small amount of about 0.027 wt % of LiNO₃ to help prevent formation of a low-index surface layer. The first, second, and third row represent ion-exchange time of 60 min, 75 min, and 90 min, respectively. The first, second, and third column of images represent the case of no material removal, 1.6-micron-target removal, and 2-micron-target removal per side. Also included are CSₖ and CS₁ values in the cases of 1-fringe spectra. It is clear from the images that 60-min ion exchange would work well with about 1 micron of removal per side is applied; the 75-min ion exchange works well for removal target around 1.6 μm, but is not adequate for 2-micron removal because it leaves no space for variability in ion exchange and removal amount around their targets. The 90-min ion exchange works well with 1.7-micron and 2-micron removal per side, and can comfortably accommodate 2.1-micron removal.

FIG. 13B shows RNF stress profile for the case of 90-min ion exchange and 2-micron removal per side, where the specimen thickness is about 0.42 mm. The profile features a center tension of about 43 MPa, a DOC of 79 micron, or about 18.8% of the thickness, tension area of about 7.88 MPa*mm, representing about 18.7 MPa when normalized to the specimen thickness.

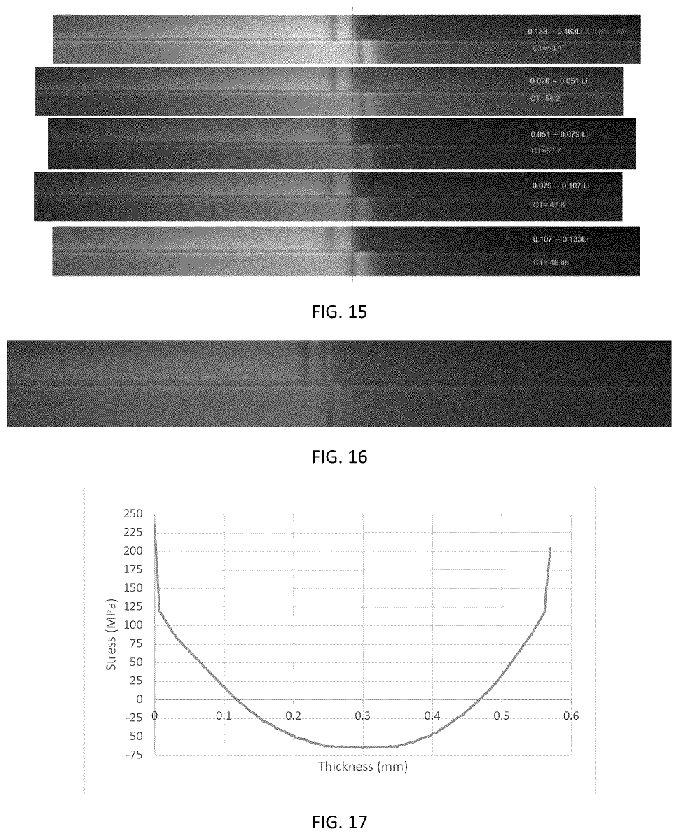

FIG. 15 shows an example of how the 1-fringe target spectrum changes in response to changes in the ion-exchange bath, when the ion-exchange time and temperature are unchanged. The five images show five different ion-exchange cases done in the same bath. The second image corresponds to the first ion exchange, wherein the bath having about 20 wt % NaNO₃ and 80 wt % KNO₃ had only 0.02 wt % LiNO₃ added to prevent low-index layer formation. This image represents the fresh-bath high-CS version of the inventive product. The bath had 200 g of salt, and four pieces of glass-ceramic with dimensions 25 mm×25 mm×0.6 mm were immersed in each ion-exchange run. This represents loading density of 0.01316 _{kg}^{m}^{²}, where the for the area of the glass in square meter (m²) is counted only one of the two large surfaces of each sheet. With this loading density, each ion-exchange run increased the LiNO₃ content of the bath by about 0.03 wt %, slightly higher for the very first run, and progressively slightly lower for each subsequent run. The five example spectra are aligned such that their upper transition is located along the same vertical line. As can be seen from the combined image, with increasing LiNO₃ content in the bath between the second and the fifth mage, the 1-fringe spectrum fully retains its structure, but the lower transition and the lower fringe move progressively more to the left, indicating lower CS₁ and CSₖ, consistent with how the actual surface CS, the CSₖ, and CS₁ which is between them, change with increasing LiNO₃ fraction in the bath. The first image at the top is the prism-coupling spectrum obtained after a fifth run of ion exchange. Before the fifth run, tri-sodium phosphate (TSP) was added to the bath at the concentration of 0.6 wt %. TSP is routinely employed in the chemical strengthening of lithium-alumino-silicate glasses to capture Li ions from the bath and keep them from counteracting the desired ion exchange. As can be seen by comparison of all five spectra, the addition of the TSP has completely recovered the original shift between the upper and lower features of the spectrum, indicating that again the maximum state of compressive stress has been generated by the ion exchange. FIG. 15 thus is an example proving qualitatively the effectiveness of the 1-fringe spectrum for tracking the changes in the bath, and for quality control of the chemical strengthening. Further data also show that measuring the positions of the fringes and the CSₖ can be done with precision fully adequate for precise quality control of the product.

FIG. 16 shows the 365 nm FSM spectrum, and FIG. 17 shows the RNF stress profile, for a 0.57-mm-thick glass-ceramic article having the composition shown in Table 1 designed in part to allow the formation of a deeper K-spike to help enable already established FSM-based efficient low-cost quality control. The composition of this glass-ceramic was adjusted to allow adequate K-diffusivity for forming a spike of at least 2 fringes in both polarizations by the time the ion exchange approaches the maximum center tension. Furthermore, this glass ceramic allows higher CT to be achieved than with ALD and higher compressive stress, for more flexibility in stress-profile design. At the same time, the said higher CT levels are still far below the frangibility limit, such that for thicknesses below about 0.74 mm the stress profile can be designed to be so far from the limit that FSM-based quality control would be fully adequate without any frangibility risk. With this composition, profiles similar to these of ALD are possible, as well as higher-CT, and higher-DOC profiles, allowing a wider range of application targets to be possible. In part, the higher fringe count is also obtained on account of longer time needed for the maximum CT (4-5 hours at 500° C. at 0.6 mm, compared to only about 2.25 hours for 0.6 mm ALD at 500° C.). The example profile of FIG. 17 shows a CT of about 65 MPa, and slightly higher DOC/t ratio compared to the ALD examples.

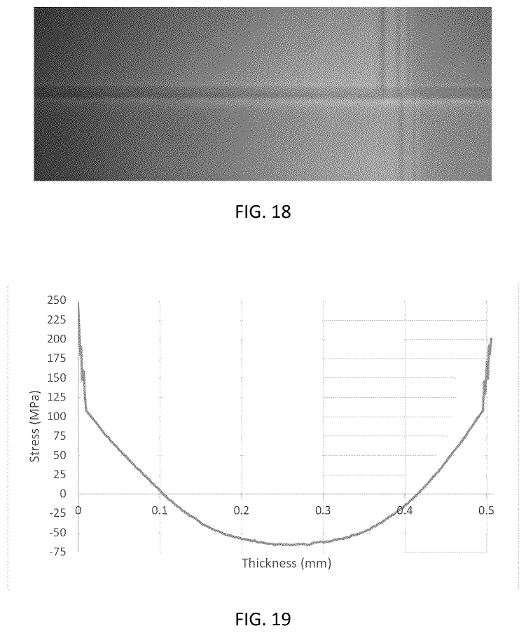

FIG. 18 shows the 365 nm FSM spectrum and FIG. 19 the RNF compressive-stress profile for a 0.5-mm specimen of glass-ceramic having the composition shown in Table 1, 3D-formed and then ion-exchanged in 25 wt % NaNO₃/0.5 wt % LiNO₃/74.5 wt % KNO₃ bath at 500° C. for 2.43 hours. The profile features center tension of about 65.2 MPa, CSₖ about 105 MPa, and a spike with DOL of 15 μm and surface CS about 250 MPa. The ion-exchange time of 2.43 hours compares well to the time to max CT, which is estimated around 3 hours for the 3D-formed material at 0.5-mm thickness.

The RNF-profiling of stress in the transparent glass ceramics offers high resolution of stress-profile measurement (about 2 microns), but has certain limitations. One limitation is that the surface CS has significant uncertainty because it is obtained from extrapolating the RNF signal, which shows a buried-peak CS artifact due to the finite resolution and the discontinuity of the stress profile at the surface. There is some uncertainty around the precise position of the surface, which translates to CS uncertainty in the extrapolation of the profile to replace the buried-peak artifact. Therefore, the surface spike of the RNF profiles is only shown as qualitative indicator of the profile shape, and not as an accurate representation of the actual spike. The other limitation of the RNF profiles is a relatively high noise when profiling transparent glass-ceramics. To reduce the noise, post-processing is used that utilizes smoothing by the LOESS algorithm, where the surface spike is excluded from the signal provided for the smoothing. The smoothing procedure thus results in a reduction of the apparent CSₖ, because the value of CS at the bottom of the spike is reduced somewhat by the smoothing procedure through application of a local linear fit over an extended region on the deeper side of the bottom of the surface spike. This leads to CSₖ in the smoothed RNF profiles being usually 10 to 25 MPa lower than the CSₖ from prism-coupling measurement of proper spectra having unperturbed TM and TE critical-angle transitions. The CS of the profile for depths exceeding the depth of the spike by about 10 micron or more should not be expected to be altered substantially by the smoothing apart from reduction of the noise.

Another aspect of RNF profiles is that the raw profiles are slightly asymmetric due to the asymmetric RNF-instrument design and operation principle. In the present disclosure, the RNF profiles were symmetrized by removing the anti-symmetric component of the profiles. This procedure is found to significantly reduce the distortion of the RNF profiles compared to actual stress profiles.

The surface CS of the 1-fringe glass ceramics articles according to Table 1 is usually in the range 330 to 390 MPa before post-ion-exchange polish when the LiNO₃ content, and is reduced by between 20 and 40 MPa per each micron of polish per side, depending on the slope of the K-spike. The surface CS was calculated by extending the ion exchange until a proper 2-fringe spectrum is obtained which allows calculation of surface CS by the assumption of a linear spike. The extended time to a 2-fringe spectrum causes the surface CS and the CSk to decrease compared to their values earlier in the ion-exchange process. That decrease can be accurately accounted for by correcting for the glass expansion between the 1-fringe and the 2-fringe conditions, by noting that the expansion is proportional to the square root of the ion-exchange time. The surface CS of the 2-fringe spectra was in the range 310 to 350 MPa in two cases studied, and the correction for the expansion leads to surface CS in excess of 350 MPa for the 1-fringe cases. In some cases, when the bath has lower Na content, such as 10 to 15 wt % NaNO₃, the surface CS of the 1-fringe spectra can reach 390 MPa, even more. In the cases designed for post-ion-exchange polish, the ion exchange time is often as long as or even exceeding the time to max-CT, and the surface CS is generally in the vicinity of 350 MPa or less prior to the polish. After 1.5 to 2 micron of polish per side, the surface CS may drop to the range 270 to 310 MPa. If the ion-exchange bath is allowed to accumulate some LiNO₃ without TSP-fixing, the surface CS declines accordingly, but is generally above 150 MPa for the preferred production-target profiles.

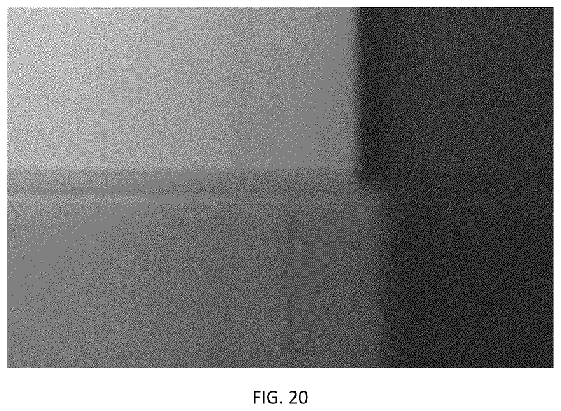

A glass example with high fracture toughness (0.89 MPα\sqrt{m}), and small thickness (0.412 mm) is also provided. For large-area applications such as tablets, laptops, and large-area smart phones (“phablets”), when the target cover-glass thickness is small, it is challenging to maintain the cover glass size within a tight size specification because the ion-exchange growth of the article is proportional to its size and the amount of ion exchange. In high-toughness lithium-containing glasses and glass-ceramics, achieving a prism-coupling spectrum with two or more fringes for quality control would tend to lead to ion exchange that is too long. To keep the growth within proper limits in that case, one would need to reduce the stress, for example the knee stress CSₖ, which is usually a driver for high fracture resistance. In such cases, the 1-fringe spectrum such as shown in FIG. 20 can be a preferred solution. In the present example, after ion exchange at 450° C. for 2.5 hours, the stress profile exhibits a peak tension in the center of 72.6 MPa, a depth of compression of 81 microns (about 20% of thickness), a tension area of 13.0 mm*MPa, and a factor Kₜ of 0.89, which happens to be the same as the fracture toughness. The average tension is:

$${σ}_{t}^{avg} = \frac{TA}{t - 2 DOC} = \frac{13. mm * MPa}{0.412 - 2 * 0.081} = 52 MPa$$

The average compressive stress in the compression region is:

$${σ}_{c}^{avg} = \frac{TA}{2 * DOC} = \frac{13.}{2 * 0.081} = 80.2 MPa$$

The ion-exchange condition was chosen such that the ion-exchange time was shorter than the time it would take for the center tension to reach a maximum with the thickness of 0.412 mm. This allows a relatively high compressive stress without too much ion-exchange growth. The weight change of the specimen following ion exchange was +0.65%. This degree of weight increase usually results in linear growth in the vicinity of only 0.1%, which is quite manageable for the applications of tablets, laptops, and large-format smart phones. In comparison, a many modern smart-phone cover glasses have ion-exchange growth exceeding 0.15%, sometimes even exceeding 0.18%, with associated weight gains of 0.9%, 1.2% and even higher. Such ion-exchange conditions are a challenge for large-format devices such as tablets and laptops.

Composition and mechanical properties of the lithium-alumino-silicate glass of the present example are provided in Table 2 below.

TABLE 2

| Component | Mol % |
|---|---|
| SiO₂ | 58.38 |
| Al₂O₃ | 17.81 |
| B₂O₃ (ICP) | 6.06 |
| MgO | 4.43 |
| CaO | 0.57 |
| Li₂O | 10.74 |
| Na₂O | 1.73 |
| K₂O | 0.20 |
| Sum | 100.00 |
| Young's Modulus (GPa) | 83.2 |
| Shear Modulus (GPa) | 33.6 |
| Poisson's Ratio | 0.236 |
| Strain Point (BBV) (10^{14.68} P) | 567.4 |

What is claimed:

1. A lithium aluminosilicate glass-based article comprising:
greater than or equal to 55.0 mol % and less than or equal to 75.0 mol % SiO₂;
greater than or equal to 1.0 mol % and less than or equal to 18.0 mol % Al₂O₃; and
greater than or equal to 9.0 mol % and less than or equal to 25.0 mol % Li₂O,
wherein
the glass-based article has a thickness less than 0.74 mm,
a fracture toughness of the mid-plane composition of the glass-base article is greater than or equal to 0.75 MPα\sqrt{m},
a depth of compression that is greater than or equal to 0.14t, where t is the thickness of the glass-based article, and
the glass-based article is designed to have a single guided mode in the prism coupling spectrum at a wavelength between 360 nm and 405 nm for at least one of the transverse-magnetic or transverse-electric polarization.

2. The glass-based article of claim 1, wherein the glass-based article has a thickness that is less than or equal to 0.67 mm.

3. The glass-based article of claim 1, wherein the glass-based article has a fracture toughness that is greater than or equal to 0.80 MPα\sqrt{m}.

4. The glass-based article of claim 1, wherein the glass-based article is a glass-ceramic.

5. The glass-based article of claim 1, wherein the glass-based article has a surface compressive stress that is greater than or equal to 150 MPa.

6. The glass-based article of claim 1, wherein the glass-based article has a CSₖ that is greater than or equal to (20+100*t), where t is the thickness of the glass-based article measured in mm.

7. The glass-based article of claim 1, wherein both a transverse-magnetic (TM) and a transverse-electric (TE) spectra have a single fringe corresponding to a guided optical mode at a wavelength between 360 nm and 405 nm.

8. The glass-based article of claim 1, wherein the spacing between one guided mode and a critical angle is greater than or equal to 0.00012 refractive-index units (RIU) for at least one of the TM and TE polarizations.

9. The glass-based article of claim 1, wherein the spacing between one guided mode and a critical angle is greater than or equal to 0.00012 RIU for both the TM and TE polarizations.

10. The glass-based article of claim 1, wherein the spacing between the one guided mode and the critical angle is greater than or equal to 0.00020 RIU for at least one of the TM and TE polarizations.

11. The glass-based article of claim 1, wherein the spacing between the one guided mode and the critical angle is greater than or equal to 0.00030 RIU for at least one of the TM and TE polarizations.

12. The glass-based article of claim 1, wherein the glass-based article has a center tension that is less than or equal to 80 MPa.

13. The glass-based article of claim 1, wherein the glass-based article has a center tension that is greater than or equal to 40 MPa.

14. The glass-based article of claim 1, wherein the glass-based article comprises:
greater than or equal to 60.0 mol % and less than or equal to 75.0 mol % SiO₂;
greater than or equal to 1.0 mol % and less than or equal to 8.0 mol % Al₂O₃; and
greater than or equal to 10.0 mol % and less than or equal to 25.0 mol % Li₂O.

15. The glass-based article of claim 1, wherein the glass-based article further comprises:
greater than or equal to 0.2 mol % and less than or equal to 1.6 mol % Na₂O;
greater than or equal to 0.05 mol % and less than or equal to 1.5 mol % K₂O; and
greater than or equal to 0.5 mol % and less than or equal to 5.5 mol % ZrO₂.

16. The glass-based article of claim 1, wherein the glass-based article is strengthened by an ion-exchange process comprising:
heating an ion-exchange solution to a temperature that is greater than or equal to 450° C. to less than or equal to 550° C., the ion exchange solution comprising the following molten salts:
greater than or equal to 12 wt % and less than or equal to 30 wt % NaNO₃;
greater than or equal to 0.02 wt % and less than or equal to 0.1 wt % LiNO₃, and
greater than or equal to 75 wt % and less than or equal to 80 wt % KNO₃; and
contacting the glass-based article with the ion exchange solution for a duration that is greater than or equal to 7 minutes and less than or equal to 210 minutes.

17. The glass-based article of claim 1, wherein the glass-based article is a 2-dimensional glass-based article.

18. The glass-based article of claim 1, wherein the glass-based article is a 2.5-dimensional glass-based article.

19. The glass-based article of claim 1, wherein the glass-based article is a 3-dimensional glass-based article.

20. An electronic product (200) comprising:
a housing (202) having a front surface (204), a back surface (206), and side surfaces (208);
a display (210); and
a cover substrate (212) disposed over the front surface (204), wherein the cover substrate (212) is a glass-based article of claim 1.
